(19) United States
(12) Patent Application Publication
(10) Pub. No.: US 2016/0189129 A1
(43) Pub. Date: Jun. 30, 2016

(54) CLOUD SERVICE SYSTEM AND METHOD FOR PROVIDING AN INTEGRATED PAYMENT SERVICE

(71) Applicant: NHN Entertainment Corporation, Seongnam-si (KR)

(72) Inventors: Eun Ju YANG, Seongnam-si (KR); Jinhee LEE, Seongnam-si (KR); Minhyuck JUNG, Seongnam-si (KR); Ji Young KIM, Seongnam-si (KR)

(21) Appl. No.: 14/853,278

(22) Filed: Sep. 14, 2015

(30) Foreign Application Priority Data
Dec. 31, 2014 (KR) 10-2014-0195260

(51) Int. Cl. G06Q 20/22; H04L 29/08

(52) U.S. Cl. CPC G06Q 20/22; H04L 67/10; H04L 67/02

(57) ABSTRACT

A cloud service method to provide an integrated payment service may include providing a service provider with a website that provides a service provider interface; receiving an application key value corresponding to at least one online application store among application key values issued from a plurality of online application stores, and registering the issued application key value and information for interaction with an online application store, input from the service provider, through the website; registering an item for an application based on information for interaction with the registered online application store; and providing a terminal in which the application is installed with a single interface generated using a payment application programming interface (API) for providing an integrated payment service in response to a request for payment for at least one item among registered items from the application.

### CROSS-REFERENCE TO RELATED APPLICATION

This application claims priority from and the benefit of Korean Patent Application No. 10-2014-0195260, filed on Dec. 31, 2014, which is hereby incorporated by reference for all purposes as if fully set forth herein.

### BACKGROUND

1. Field

The following description relates to a cloud service technology, and more particularly, to a cloud system for providing an integrated payment service to a terminal.

2. Discussion of the Background

Internet transactions may refer to selling and purchasing products and services between consumers and companies over a network. With the development of information communication and significant increase in the number of internet users, internet transactions are becoming more widely used as new economic activities. Compared to existing offline transactions, internet transactions may have advantages. Accordingly, internet shopping malls and small amount payment sites that enable users to readily make commercial transactions using payment methods such as a credit card, cash, and cyber money are being developed.

Korean Laid-Open Publication No. 10-2013-0012181 discloses a partnership cooperation system and method that enables a mart user to verify contents of an affiliated service through a cart terminal and to utilize the service based on a partnership between a discount mart and suppliers, an apparatus for managing partnership cooperation information and a driving method thereof, a cloud computing service apparatus and a driving method thereof, and a cart terminal and a driving method thereof. However, this related art discloses only technology for maintaining a long-term customer according to service diversification through a cloud computing service apparatus and does not provide a user with a convenient payment service that provides a single interface generated using a payment application programming interface (API) for an integrated payment service with respect to various markets.

### SUMMARY

Exemplary embodiments provide a cloud service system and method that may provide a single interface for an integrated payment service in response to a request for payment for a registered item from an application.

Exemplary embodiments also provide a cloud service system that may provide a security enforced integrated payment service.

Additional features of the invention will be set forth in the description which follows, and in part will be apparent from the description, or may be learned by practice of the invention.

An exemplary embodiment discloses a cloud service method of a cloud service system, the method including providing a service provider with a website that provides a service provider interface; receiving an application key value corresponding to at least one online application store among application key values issued from a plurality of online application stores, and registering the issued application key value and information for interaction with an online application store, input from the service provider, through the website; registering an item for an application based on information for interaction with the registered online application store; and providing a terminal in which the application is installed with a single interface generated using a payment application programming interface (API) for providing an integrated payment service in response to a request for payment for at least one item among registered items from the application.

An exemplary embodiment also discloses a cloud service system including an interfacer configured to provide a service provider with a website that provides a service provider interface; an online market registerer configured to receive an application key value corresponding to at least one online application store among application key values issued from a plurality of online application stores, and to enable the service provider to register the issued application key value and information for interaction with an online application store through the website; an item registerer configured to register an item for an application based on information for interaction with the registered online application store; and a payment provider configured to provide a terminal in which the application is installed with a single interface generated using a payment API for providing an integrated payment service in response to a request for payment for at least one item among registered items from the application.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an operation of a cloud service system according to an exemplary embodiment.

FIG. 2 is a block diagram illustrating a configuration of a cloud service system according to an exemplary embodiment.

FIGS. 3A through 3O illustrate examples of an interface for constructing an infrastructure service at a cloud service system according to an exemplary embodiment.

FIG. 4 is a flowchart illustrating a cloud service method of a cloud service system according to an exemplary embodiment.

FIG. 5 illustrates an operation of a cloud service system to provide a campaign according to an exemplary embodiment.

FIG. 6 is a block diagram illustrating a configuration of a cloud service system to provide a campaign according to example an exemplary embodiment.

FIG. 7 illustrates a process of providing a campaign at a cloud service system according to an exemplary embodiment.

FIGS. 8A through 8H illustrate examples of an interface for constructing an infrastructure service at a cloud service system according to an exemplary embodiment.

FIG. 9 is a flowchart illustrating a cloud service method of a cloud service system to provide a campaign according to an exemplary embodiment.

FIG. 10 is a block diagram illustrating a configuration of a cloud service system to provide initial information according to an exemplary embodiment.

FIG. 11A through 11J illustrate examples of an interface for providing initial information at a cloud service system according to an exemplary embodiment.

FIG. 12 is a flowchart illustrating a cloud service method of a cloud service system to provide initial information according to an exemplary embodiment.

FIG. 13 is a block diagram illustrating a configuration of a cloud service system to provide an integrated payment service according to an exemplary embodiment.

FIG. 14 illustrates an operation of a cloud service system to provide an integrated payment service according to an exemplary embodiment.

FIG. 15 illustrates a process of performing an integrated payment service at a cloud service system according to an exemplary embodiment.

FIGS. 16A through 16C illustrate examples of an interface for providing an integrated payment service at a cloud service system according to an exemplary embodiment.

FIG. 17 is a flowchart illustrating a cloud service method of a cloud service system to provide an integrated payment service according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of components, etc., may be exaggerated for clarity and descriptive purposes. Also, like reference numerals denote like elements.

When a component is referred to as being “on,” “connected to,” or “coupled to” another component, it may be directly on, connected to, or coupled to the other component or intervening components may be present. When, however, a component is referred to as being “directly on,” “directly connected to,” or “directly coupled to” another component, there are no intervening components present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various features, these features should not be limited by these terms. These terms are used to distinguish one feature from another. Thus, a first feature could be termed a second feature without departing from the teachings of the present disclosure.

Spatially relative terms, such as “beneath,” “below,” “lower,” “above,” “upper,” and the like, may be used herein for descriptive purposes, and, thereby, to describe one feature's relationship to another feature as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, exemplary embodiments are described in detail with reference to the accompanying drawings.

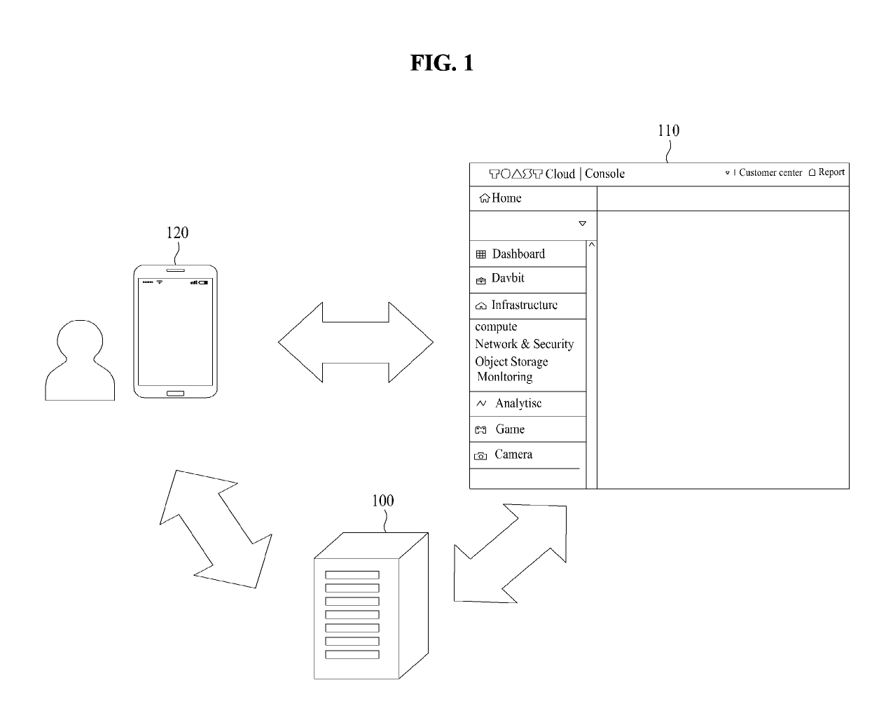

FIG. 1 illustrates an operation of a cloud service system according to an exemplary embodiment.

The cloud service system 100 refers to a public cloud system for providing a service that may be developed and may provide various services used for, for example, an infrastructure, a development, a test, an operation and technology support, and commercialization.

The cloud service system 100 may provide a service provider with a website 110 that provides a service provider interface. The service provider may utilize the website 110 by joining the website 110 provided from the cloud service system 100. Here, the service provider may indicate an application developer and an application operator for providing a service to a terminal 120. A variety of services may be provided through data transmission and reception among the website 110, the terminal 120, and the cloud service system 100.

The cloud service system 100 may provide the website 110 that provides a service provider interface in order to construct a cloud infrastructure and manage a network, and may transmit the website 110 to the terminal 120 based on information input from the service provider.

Depending on the necessity of the service provider, the cloud service system 100 may generate various types of instances, and may generate the instances using a hardware template, for example, “flavor”, and a software template, for example, “image”. The hardware template may include a combination, for example, of vCPU, a memory, and a disk. The software template, as a primary element that constitutes an instance, may be a template of an application installed with an operating system (OS). The cloud service system 100 may provide a public image, and may generate and use a new image based on the necessity of the service provider.

The cloud service system 100 may include product services such as, for example, a charged product service and a free product service provided to the service provider. The cloud service system 100 may receive payment information from the service provider in response to the service provider generating a project including the charged product service, and may reject payment information from the service provider in response to the service provider generating a project including the free product service.

The cloud service system 100 may provide an interface for receiving information for generating a volume of an instance from the service provider through the website 110, and may generate the volume based on information for generating the volume of the instance input from the service provider, and may output an instance connected to the generated volume.

The cloud service system 100 may provide an interface for receiving information for generating a volume snapshot from the service provider to store a state of the volume through the website 110, and may restore a state of the volume to a volume state corresponding to a predetermined point in time by generating volume snapshots based on information for generating the volume snapshot received through the interface, and by generating a new volume using the generated volume snapshots.

The cloud service system 100 may set a security group capable of controlling a network access with respect to an instance. A plurality of rules may be designated for a single security group. Each rule may be applied to ingress and egress network traffic. The cloud service system 100 may set a plurality of security groups with respect to a single instance and accordingly, may increase efficiency of controlling traffic.

The cloud service system 100 may support a key-pair authentication to remotely access a Linux instance, and needs to designate a key pair to generate an instance. Thus, when a key pair generated by the service provider is absent, the cloud service system 100 may provide a key pair generation menu interface through the website 110, and the service provider may generate a new key pair through a key pair generation menu. In this case, the generated key pair needs to be managed so as not to be externally exposed.

The cloud service system 100 may provide a virtual network to the service provider so that the service provider may define the virtual network. The cloud service system 100 may control a network through subnet separation and gateway settings by generating a router within the virtual network. In this case, the cloud service system 100 may configure a more flexible infrastructure using an external connection network and a user defined private network. Also, the service provider may verify network setting from a network topology provided from the cloud service system 100.

The cloud service system 100 needs to allocate a public Internet Protocol (IP) to provide a service to a system outside of the cloud system. Here, the cloud service system 100 may allocate the public IP using a floating IP. The floating IP is connected to a user account and thus, is not released irrespective of deleting an instance. The same IP may be allocated to another instance. Through connection to a domain name server (DNS), the cloud service system 100 may quickly recover a fault by connecting a floating IP in use to a normal server which may increase the service quality.

The cloud service system 100 may distribute network traffic to a plurality of instances using a load balancer. Since network traffic is controlled to be distributed by automatically detecting a faulty instance based on a health check pattern set by a user in addition to load distribution, it is possible to guarantee the high availability of a user service. The cloud service system 100 may generate a plurality of load balancers for each service within a single network.

The cloud service system 100 may output a list of at least one instance selected by the service provider and may provide information about a state of the output at least one instance as a graph, through the website 110. Information of the state of the instance may include, for example, at least one of a name of a server, an IP, a usage amount of a central processing unit (CPU), a usage amount of a memory, a usage amount of a disk, a disk byte read per second, a disk byte used per second, a network byte received per second, a network byte transmitted per byte, a server state, and a server operation time.

When the analyzed instance state exceeds a predetermined threshold, the cloud service system 100 may provide an interface for transmitting an e-mail or a short message service (SMS) to an alarm receiver, for example, the terminal 120. When the analyzed instance state exceeds the threshold, the cloud service system 100 may output a transmitted e-mail or an SMS list through the website 110.

The cloud service system 100 may provide the website 110 that provides a service provider interface, in order to provide a campaign, and may transmit the website 110 to the terminal 120 based on information input from the service provider.

The service provider may register an application by inputting information about the application through the website 110. The cloud service system 100 may provide a plurality of campaign templates to the service provider through the website 110, and the service provider may select at least one campaign template from among the plurality of campaign templates. For example, the campaign templates may include an early leave preventing template, a leave risk care template, an item repurchase inducement template, and a user return inducement template.

The cloud service system 100 may provide an interface for receiving campaign information from the service provider for each item of the selected campaign template through the website 110. The service provider may input campaign information into items of the selected campaign template, and the cloud service system 100 may generate a campaign for the registered application based on the input campaign information. Template items of the selected campaign may include at least two items among, for example, a campaign name, a campaign target, a campaign schedule, a platform to perform a campaign, a country in which the campaign is to be performed, a campaign display method, a push use for the campaign, providing of compensation and compensation details.

The cloud service system 100 may display different types of campaign templates through the website 110, and may target a portion of terminals based on a type of a campaign template selected from among the plurality of campaign templates. The cloud service system 100 may provide the generated campaign to at least a portion of terminals in which the registered application is installed.

The cloud service system 100 may push the campaign to the targeted terminal 120 based on information about a campaign providing time included in campaign information received for each item of the selected campaign template.

Also, through the website 110, the service provider may input a campaign mission to be carried out, an accomplishment value preset for accomplishing the campaign mission, a type of compensation to be provided in response to accomplishing the campaign mission, and a compensation value to be provided. The terminal 120 may receive the campaign, and may carry out the campaign mission through the campaign. The cloud service system 100 may monitor that the terminal 120 has accomplished the campaign mission using the predetermined accomplishment value, and in response to accomplishment of the campaign mission, may provide compensation to the application based on a compensation type and a compensation value.

The cloud service system 100 may provide the website 110 that provides a service provider interface to provide initial information, and may transmit, to the terminal 120, initial information included in launching information that is updated based on information input from the service provider.

The service provider may input alterations of launching information through the website 110, and may manage and update the launching information. For example, the launching information may include initial information required when the terminal 120 executes an application to be provided with a service from the service provider.

When the service provider generates a project, a name of the project, a version of the project, a gateway address, a port number, and an encryption key may be output and currently set initial information may be referred to. The cloud service system 100 may provide an interface for generating a parameter to the application through the website 110, and the service provider may generate a parameter for providing initial information by inputting information for generating the parameter.

The cloud service system 100 may provide a logic definition interface for defining launching information through the website 110, and the service provider may generate launching information by inputting information for defining logic. When parameter information and the generated launching information differ from each other, the cloud service system 100 may provide initial information including the updated launching information to the terminal 120.

The cloud service system 100 may output previously distributed launching information through the website 110, and may restore or output the previously distributed launching information again.

The cloud service system 100 may notify the terminal 120 about a message including an inspection schedule of the application or an event during a period of time set by the service provider, and may stop a service and notify the terminal 120 about an inspection message during the period of time set by the service provider. The cloud service system 100 may notify upgrade of a previous version of an application, forcefully update an application, and disallow an access of a previous version application, and may provide a function selected by the service provider to the terminal 120.

When a service error occurs due to a specific user terminal or an OS version upgrade, the cloud service system 100 may limit a service against a terminal in which the service error is to occur or a terminal including an upgraded OS version.

The cloud service system 100 may provide the website 110 that provides a service provider interface to provide an integrated payment service, and may transmit the website 110 to the terminal 120 based on information input from the service provider.

The service provider may receive an application key value corresponding to at least one online application store among application key values issued from a plurality of online application stores. The service provider may input and thereby register the issued application key value and information for interaction with an online application store through the website 110. The service provider may register an item of an application based on the registered information for interaction with the online application store. The website 110 may output an online application store list including information for interaction with the online application store input from the service provider. Here, information for interaction with the online application store may include at least one of an ID of an application for interaction with the online application store, an application name, a package name of an application registered to the online application store, a state of an online application store, and a registration date on which the online application store is registered.

The terminal 120 in which the application is installed may request a payment for an item, and the cloud service system 100 may provide the terminal 120 with a single interface generated using a payment application programming interface (API) for providing an integrated payment service. A user using the terminal 120 may request a payment for an item using the single application. Here, the single interface may control the terminal 120 to process at least one integrated payment service among a payment request for an item from an online application store, a payment verification request for determining whether the payment for the item is accurately performed from the online application store, and a payment details reference request for referring to payment details of the item.

The cloud service system 100 may determine whether the requested payment for the item is performed, may inspect the payment validity using a payment purchase token for maintaining security, and may transfer the purchased item to the application in response to completing the requested payment for the item. In this example, when the requested payment for the item is not performed, the user may refer to unused payment details for verifying whether the payment for the item is completed, through the website 110.

The cloud service system 100 may provide a payment information reference interface for outputting payment details for a registered item through the website 110. The user may select an ID of a market from information for interaction with the online application store and may input a start date and an end date for verifying payment information about the ID of the market through the website 110. In response thereto, payment information details may be output. Here, the payment information details may include at least one of an application ID, an ID of a market, an ID of a user, an ID of an item, a key value of an application, a payment state of the item, a price of the item, a payment date of the item, and a refund date of the item. The payment state of the item may include at least, for example, one of a payment in progress, a payment success, and a payment failure.

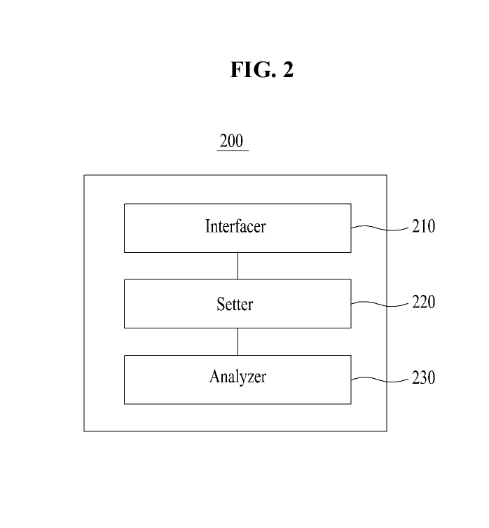

FIG. 2 is a block diagram illustrating a configuration of a cloud service system according to an exemplary embodiment.

The cloud service system 200 refers to a system to manage a network and an instance required for constructing a service infrastructure, and may configure an infrastructure if necessary. For example, the infrastructure may be constructed based on charge per use. The cloud service system 200 may include an interfacer 210, a setter 220, and an analyzer 230.

The interfacer 210 may provide a service provider with a website that provides a service provider interface. The cloud service system 200 may provide the service provider with the website that provides the service provider interface to the service provider and accordingly, the service provider may more easily construct an infrastructure and may manage a network.

The setter 220 may generate a project in response to a computing service request from the service provider, may generate a plurality of types of instances corresponding to the generated project, and may set computing resources for managing the generated instances and a network, through the website.

The setter 220 may display information about a plurality of predefined hardware templates and a plurality of predefined software templates to the service provider through the website. The setter 220 may verify at least one hardware template selected by the service provider from among the plurality of hardware templates and at least one software template selected by the service provider from among the plurality of software templates through the website, and may generate an instance including at least one verified hardware template and software template.

The setter 220 may include a name of the instance, a software template of the instance, and a hardware template of the instance, and may include, for example, at least one of an instance count, a key pair for connection and security of the instance, and a security group setting for controlling a network access to the instance, and network information to be applied to the instance.

The setter 220 may receive payment information from the service provider in response to the service provider generating a project including a charged product service, and may reject payment information from the service provider in response to the service provider generating a project including a free product service.

The setter 220 may maintain a floating IP pool, may provide a floating IP allocation interface for selecting a floating IP corresponding to an instance selected by the service provider from the floating IP pool, and may allocate the selected floating IP to the selected instance through the website. The selected instance may communicate with an external network using the allocated floating IP.

The setter 220 may provide an interface for receiving information for generating a volume of an instance from the service provider through the website, may generate the volume based on information for generating the volume of the instance received through the interface, and may output the instance connected to the generated volume.

The setter 220 may provide an interface for receiving information for generating a volume snapshot from the service provider to store a state of the volume through the website, and may restore a state of the volume to a volume state corresponding to a predetermined point in time by generating the volume snapshot based on information for generating volume snapshots received through the interface, and by generating a new volume using the generated volume snapshots.

The setter 220 may provide an interface for receiving information for generating a security group to set the security group from the service provider, and may generate the security group based on information for generating the security group input from the service provider, through the website. The setter 220 may provide an interface for receiving a rule for controlling a network with respect to the generated security group from the service provider, and may notify traffic allowed from the security group based on the rule input from the service provider.

The setter 220 may provide an interface for receiving information for setting a network through the website, and may generate a network for managing a subnet and a router based on information for setting the network input from the service provider.

The setter 220 may provide an interface for receiving information for generating a load balancer through the website, and may select a load balancing instance that responds to information for generating the load balancer input from the service provider. The setter 220 may provide an interface for receiving state information of the load balancing instance at predetermined intervals through the website, and may inspect a state of the load balancing instance based on state information of the load balancing instance input from the service provider. The setter 220 may distribute traffic to the load balancing instance in response to inspecting the state of the load balancing instance.

The analyzer 230 may analyze a state of at least one instance selected by the service provider from among the generated instances, and may provide the service provider with information about the analyzed instance state through the website.

The analyzer 230 may output a list of at least one instance selected by the service provider, and may provide information about a state of the output of the at least one instance as a graph.

The analyzer 230 may provide an interface for transmitting an e-mail or an SMS to an alarm receiver when the analyzed instance state exceeds a predetermined threshold, and may output a transmitted e-mail or an SMS list through the website when the analyzed instance state exceeds the threshold.

A storage (not shown) may provide a container generation interface for storing a plurality of objects from the service provider through the website, may generate a container based on information input from the service provider, and may upload/download an object.

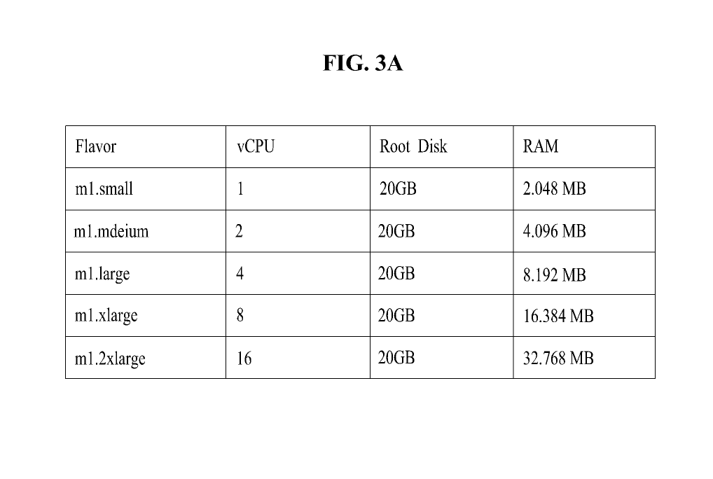

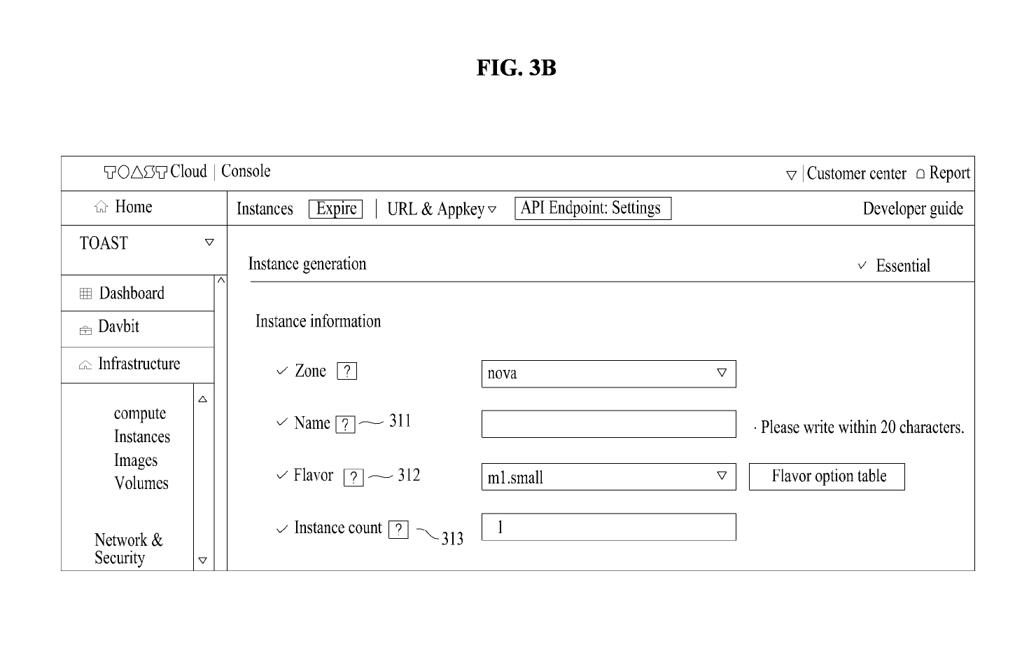

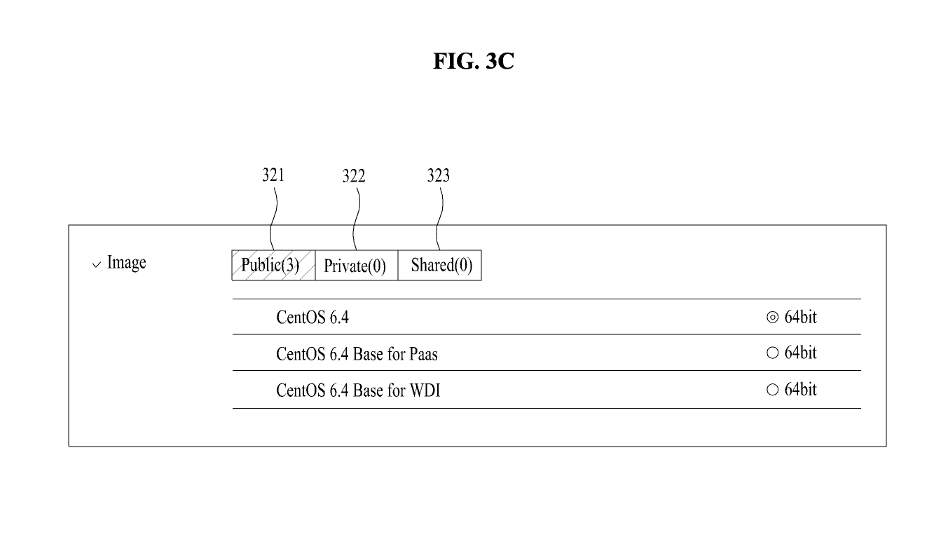

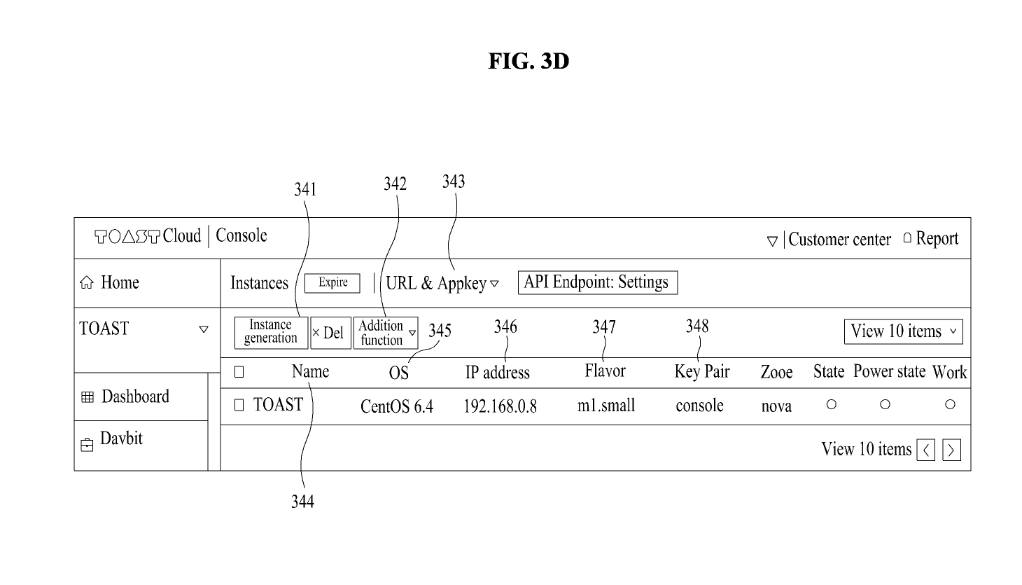

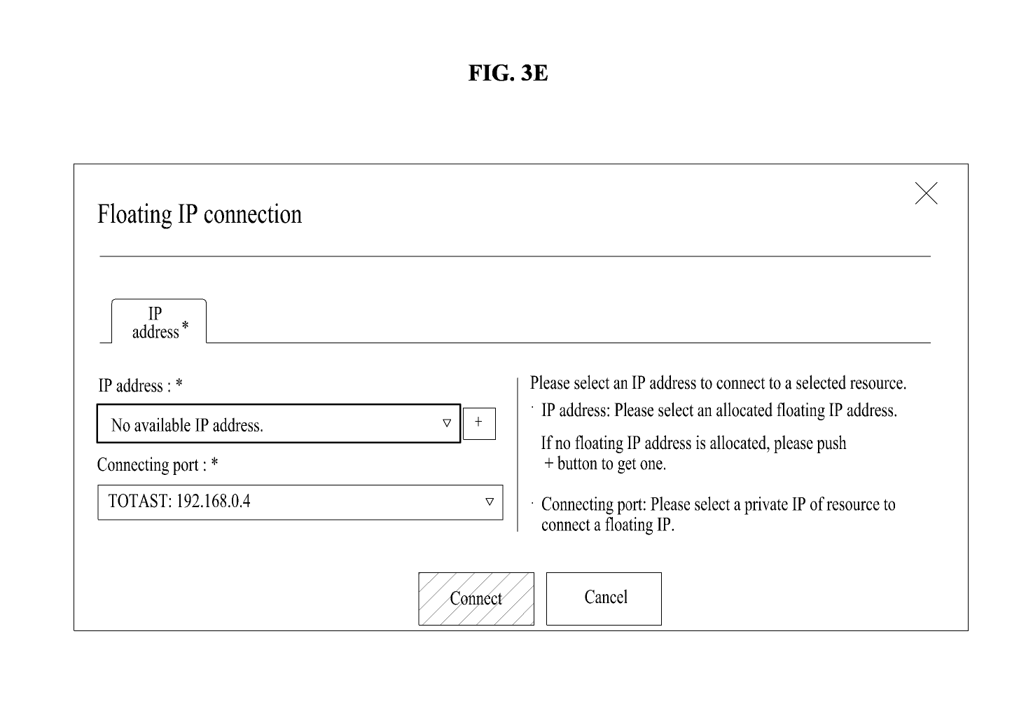

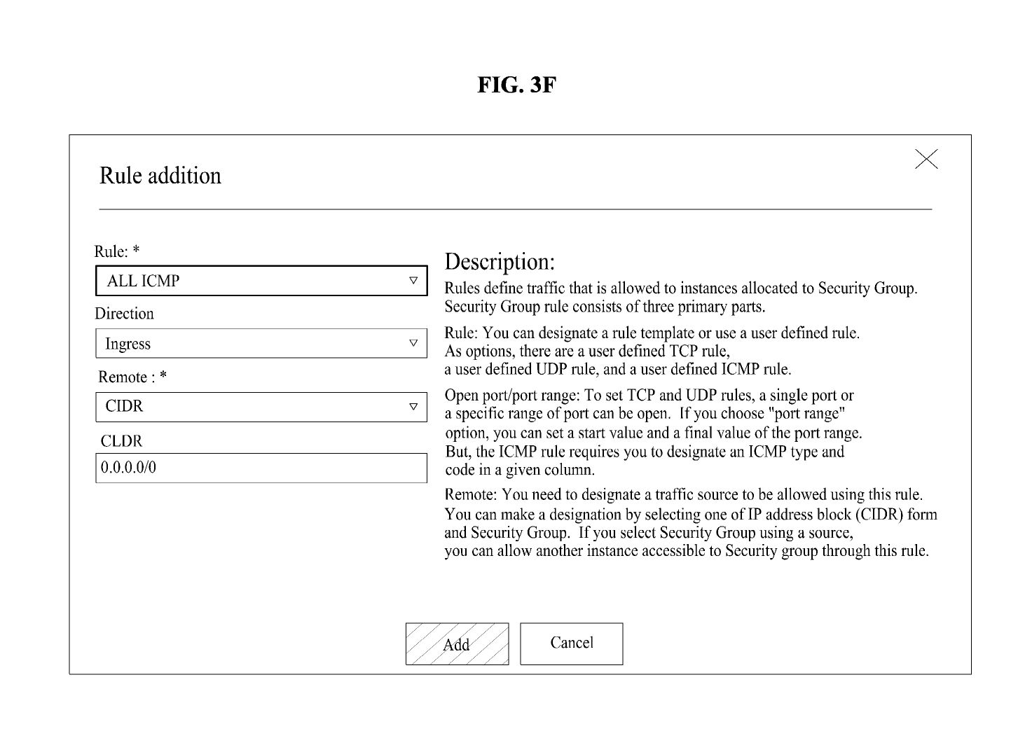

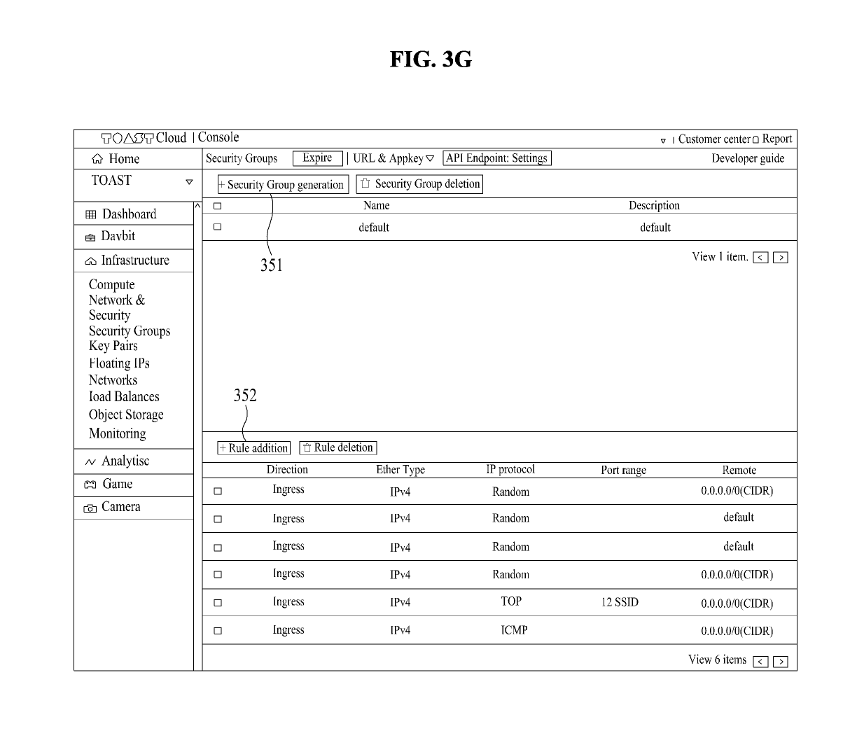

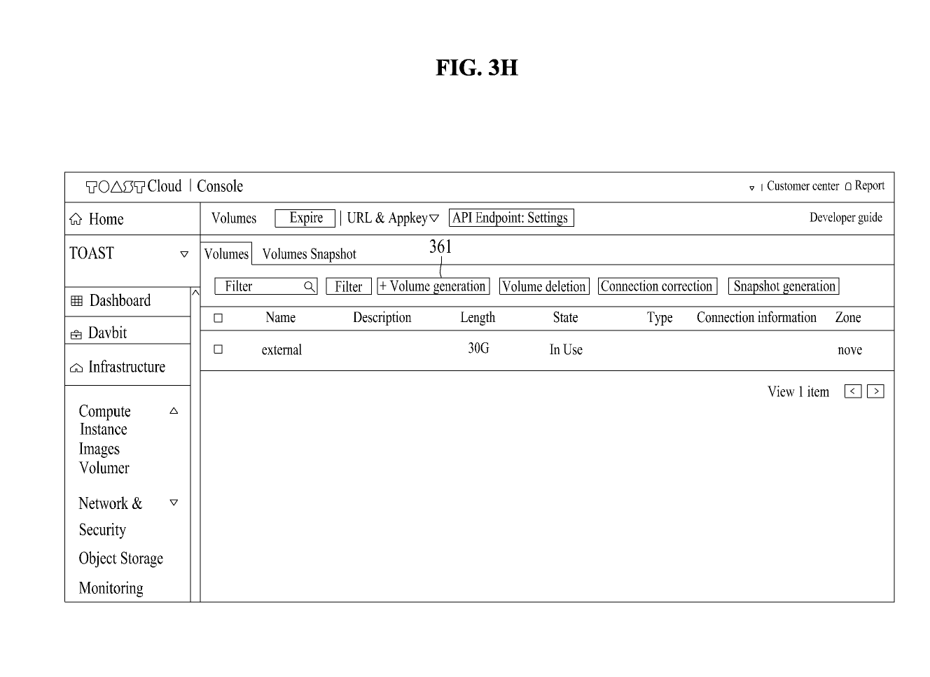

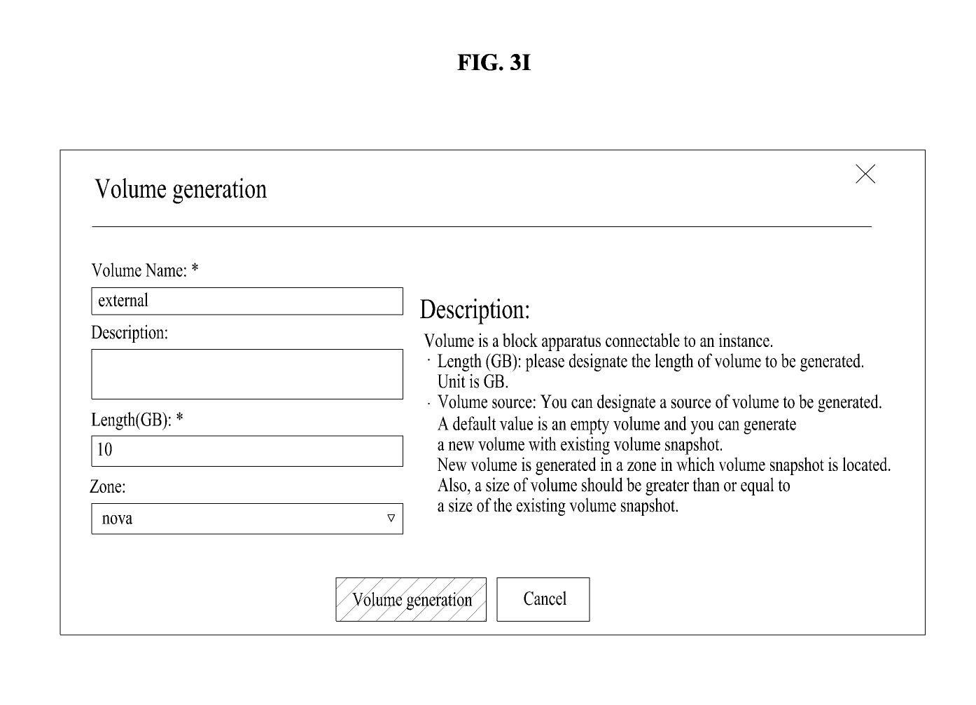

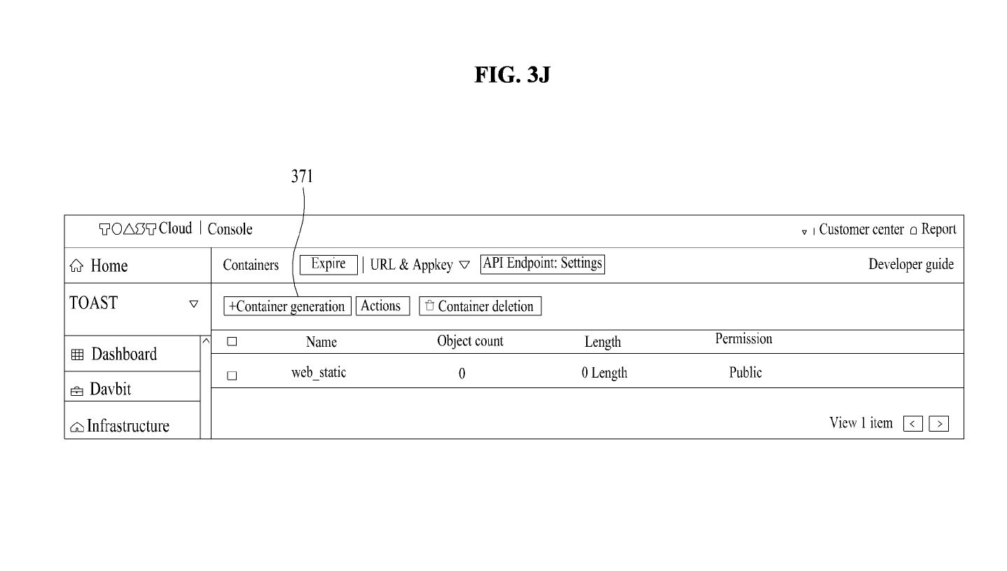

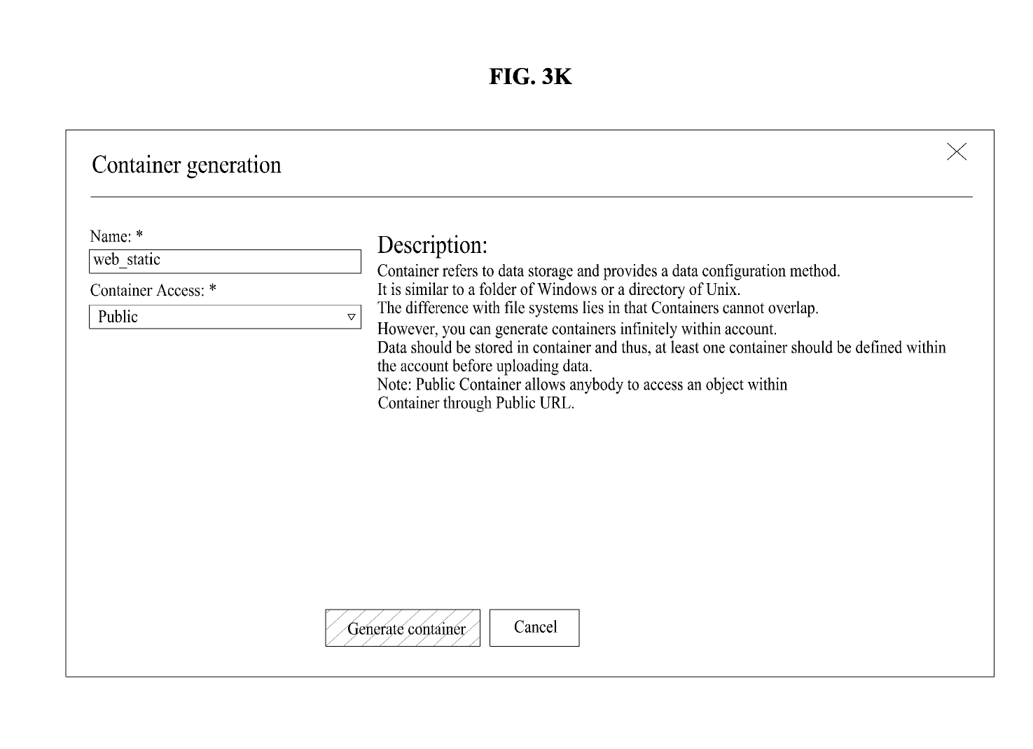

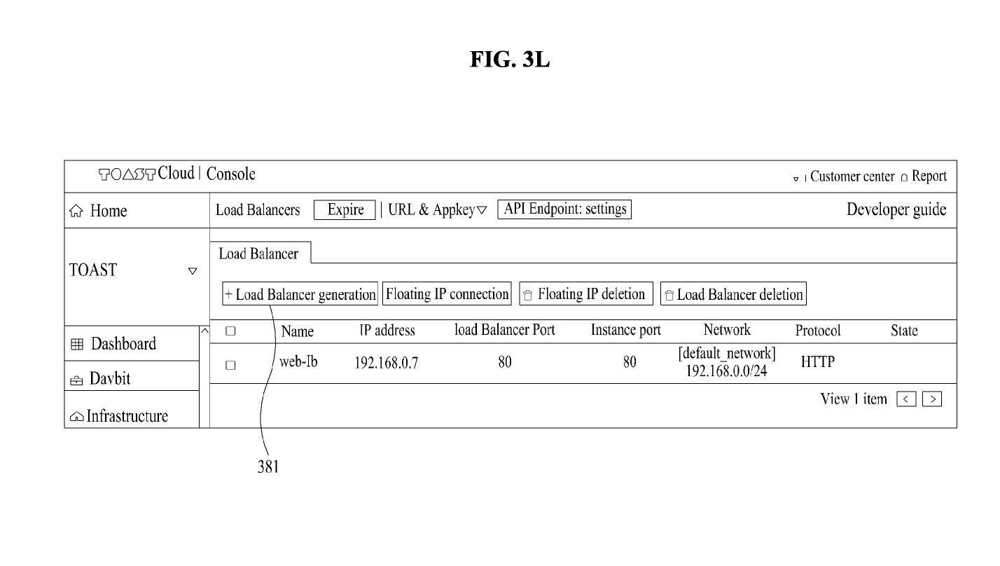

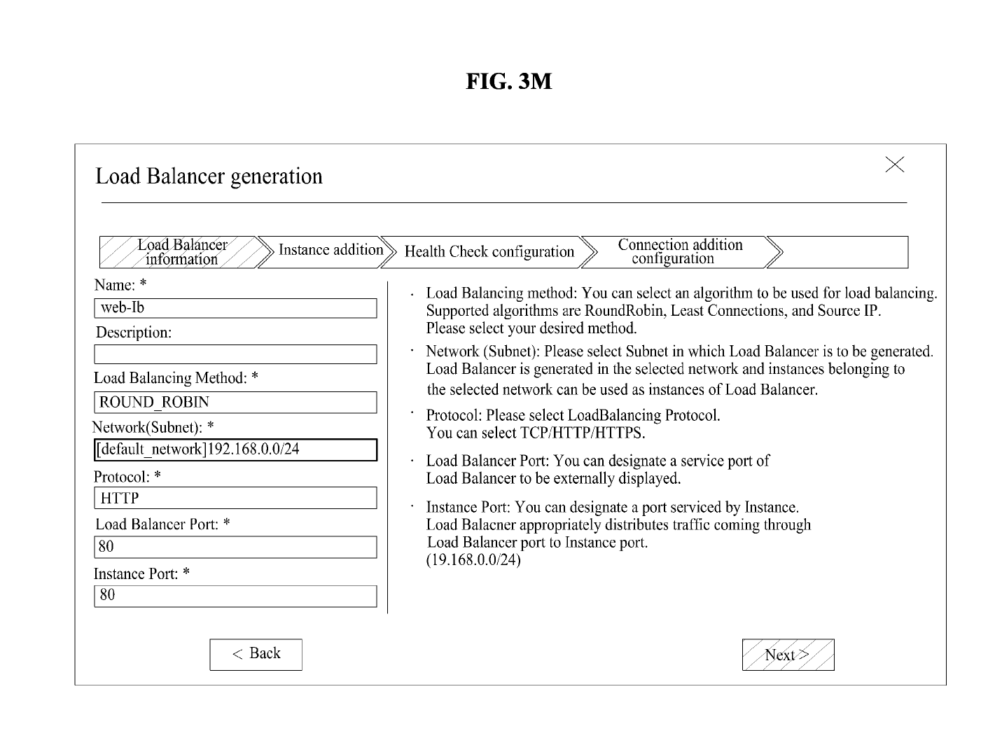

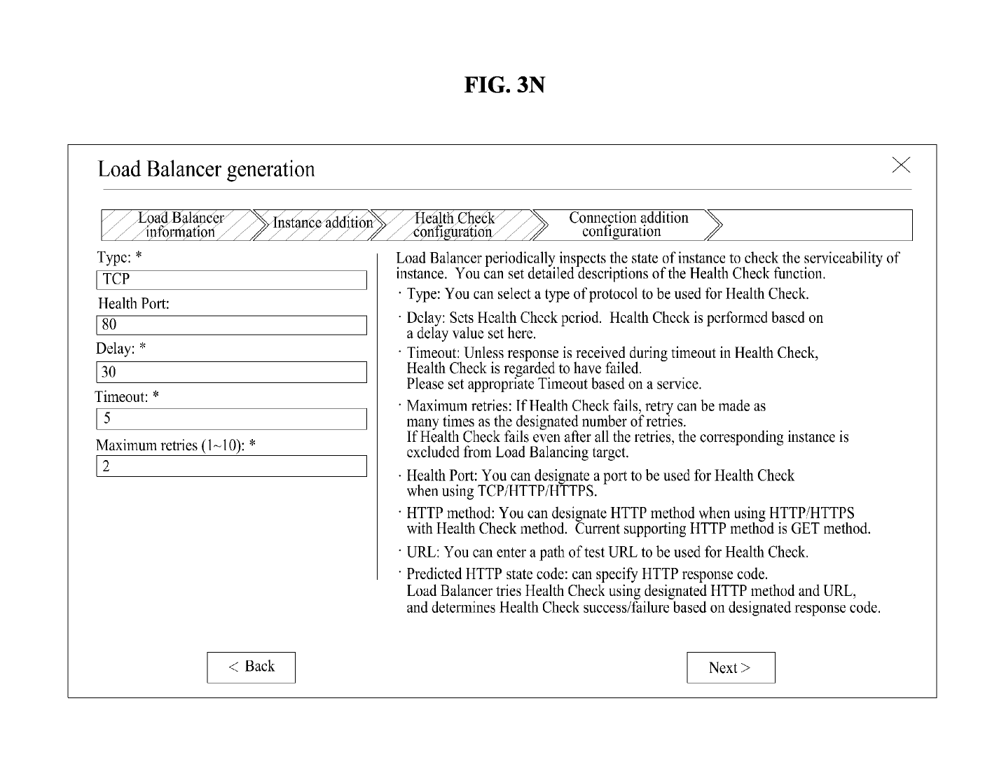

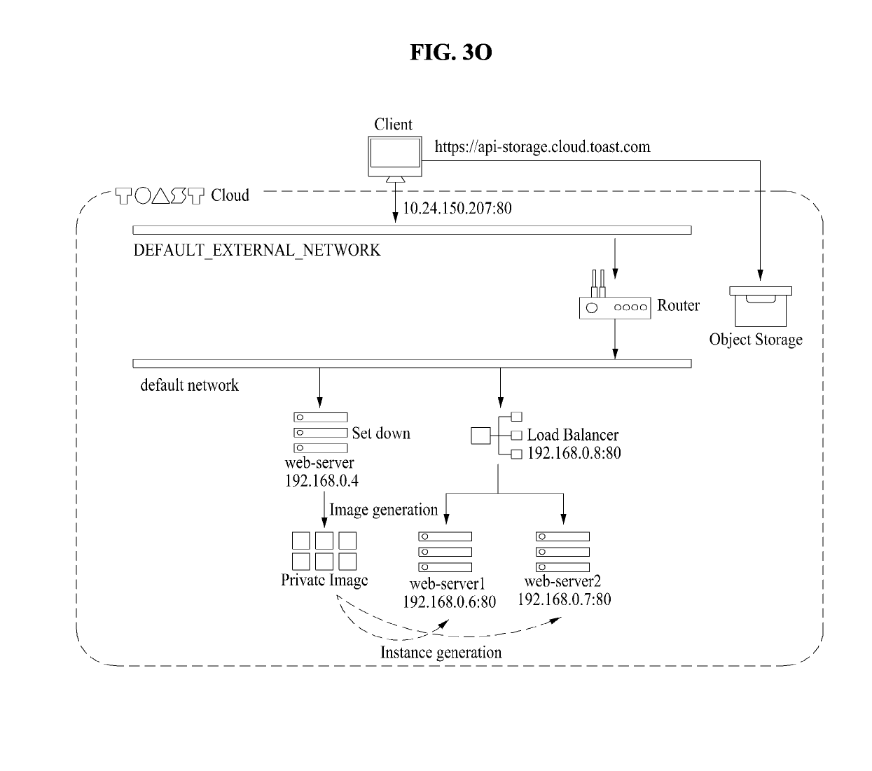

FIGS. 3A through 3O illustrate examples of an interface for constructing an infrastructure service at a cloud service system according to an exemplary embodiment.

Referring to FIG. 3A, the cloud service system may display information about a plurality of predefined hardware templates such as, for example, “flavor,” and information about a plurality of predefined software templates such as, for example, “image,” to a service provider through a website. For example, a hardware template may include a combination of vCPU, a memory, and a disk. Root disk may be provided based on volume storage. A software template, as an element that constitutes an instance, may be a template of an application installed with an OS and may provide a public image.

The cloud service system may verify at least one hardware template selected by the service provider and at least one software template selected by the service provider, through the website. The cloud service system may generate an instance including at least one verified hardware template and one software template.

Referring to FIG. 3B, the cloud service system may generate a project in response to a computing service request from the service provider through the website, and may generate a plurality of types of instances with respect to the generated project. The cloud service system may provide an interface for generating an instance through the website. The service provider may input information of an instance to generate the instance. For example, the service provider may input a zone for generating an instance, a name of the instance 311, a hardware template (e.g. “flavor”) 312, and instance count 313. The instance may be generated based on information of the instance input from the service provider.

Referring to FIG. 3C, the cloud service system may provide an interface for selecting a software template (e.g. “image”). Public image 321, as a provided image, may indicate a safe image of which security verification is completed. Private image 322 may indicate a user image newly generated using an instance generated through a public image 321. Shared image 323 may indicate an image sharable between projects owned by a user. For example, the service provider may select 64 bit of ContOS 6.4 of the public image 321.

Referring to FIG. 3D, the cloud service system may provide an interface for generating an instance and may output the instance generated based on information input from the service provider. The cloud service system may provide, for example, an instance generation interface 341 for generating an instance, an addition function interface 342 for providing a function of adding an interface, and a URL & Appkey interface 343 through a website.

The addition function interface 342 may provide an addition function such as connecting a floating IP to the service provider or setting a security group. The service provider may perform a key-pair authentication to remotely access a Linux instance by selecting the URL & Appkey interface 343. A key pair needs to be designated to generate the instance. A new key pair may be generated through a key pair generation menu when the generated key pair is absent.

With respect to the instance generated by the service provider through the website, the cloud service system may include and thereby output at least one of a name 344 of the instance, an OS 345 of the instance, an IP address 346 of the instance, Flavor 347 of the instance, a key pair 348 of the instance, a zone of the instance, and a state of the instance.

Referring to FIG. 3E, the cloud service system may provide an interface for setting a floating IP through the website. The service provider may select a floating IP corresponding to an instance selected by the service provider from the floating IP pool, and may communicate with an external network using the allocated floating IP. Also, the service provider may select a port to connect the floating IP.

Referring to FIGS. 3F and 3G, the cloud service system may provide an interface for receiving a name and a description for setting a security group from the service provider through the website. The service provider may select a security group generation button 351 for generating a security group, and may input a name and a description for generating the security group.

The cloud service system may provide an interface for receiving a rule for controlling a network with respect to the generated security group from the service provider. The service provider may select a rule addition button 352 and may input information for generating the rule. For example, to add a rule, the service provider may designate a rule template or may utilize a user defined rule. The service provider may select a user defined transmission control protocol (TCP) rule, a user defined user datagram protocol (UDP) rule, or a user defined Internet control message protocol (ICMP) rule, and may select a traffic source to be allowed using a single port or a predetermined port range for setting a TCP rule and a UDP rule. The cloud service system may output information about the group and the rule generated by the service provider.

The cloud service system may provide, for example, an interface for setting the security group to be provided through the website to a service provider having a manager right among service providers having the manager right and a member right. The service provider having the manager right among service providers may set the security group.

Referring to FIG. 3H, the cloud service system may provide an interface for generating a volume of an instance through the website. The service provider may input information for generating the volume of the instance by selecting a volume generation button 361. The cloud service system may output information corresponding to the generated volume through the website. Referring to FIG. 3I, the cloud service system may provide an interface for inputting information for generating the volume through the website. The service provider may input, for example, a name of the volume, a length of the volume to be generated, and a zone in which the volume is to be generated.

The cloud service system may provide an interface for inputting information for generating a volume snapshot to store a state of the volume through the website. The cloud service system may restore a state of the volume to a volume state corresponding to a predetermined point in time by generating volume snapshots based on information for generating the volume snapshot received through the interface, and by generating a new volume using the generated volume snapshots.

Referring to FIG. 3J, the cloud service system may provide a container generation interface for storing a plurality of objects from the service provider through the website. The service provider may generate a container by selecting a container generation button 371. Referring to FIG. 3K, the cloud service system may provide an interface for generating a container through the website. The service provider may generate the container by inputting a name of the container and an object approach range within the container.

Referring to FIG. 3L, the cloud service system may provide a load balancer generation interface for generating a load balancer through the website, and may output the load balancer generated based on information input from the service provider. The service provider may generate the load balancer by selecting a load balancer button 381. Referring to FIG. 3M, the cloud service system may provide an interface for generating a load balancer through the website. The service provider may input at least one of a name of a load balancer, an algorithm to be used for load balancing, a network in which the load balancer is to be generated, a load balancing protocol, a service port of the load balancer to be externally exposed, and a port serviced by an instance.

Referring to FIG. 3N, the cloud service system may provide an interface for inspecting a state of a load balancing instance at predetermined intervals to verify whether an instance is serviceable, through the website. The service provider may input state information of a load balancing instance, for example, a type of a protocol to be used for an inspection, an inspection interval, a timeout, and a number of retries. The cloud service system may inspect the state of the load balancing instance. The cloud service system may distribute traffic to the load balancing instance in response to inspecting the state of the load balancing instance.

The service provider may generate an instance through the interface provided from the cloud service system through the website, and may construct a network. FIG. 3O illustrates an example of descriptions constructed based on information generated with reference to FIGS. 3A through 3N.

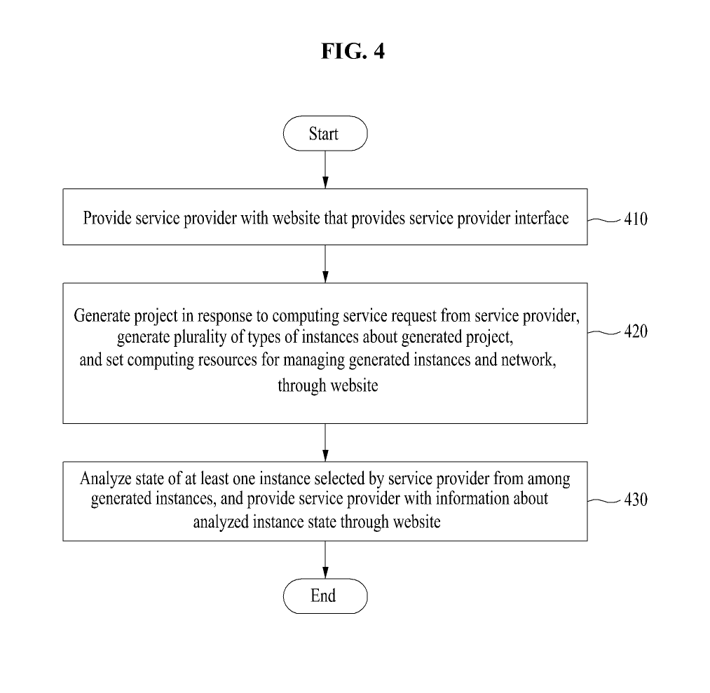

FIG. 4 is a flowchart illustrating a cloud service method of a cloud service system according to an exemplary embodiment.

In operation 410, the cloud service system may provide a service provider with a website that provides a service provider interface.

In operation 420, the cloud service system may generate a project in response to a computing service request from the service provider, may generate a plurality of types of instances corresponding to the generated project, and may set computing resources for managing the generated instances and a network, through the website. The cloud service system may set a name of an instance, a software template of the instance, and a hardware template of the instance based on information input from the service provider. By further receiving at least one of an instance count, a key pair for connection and security of the instance, and a security group setting for controlling a network access to the instance, and network information for applying to the instance, computing resources for managing the instance and the network may be set.

In operation 430, the cloud service system may analyze a state of at least one instance selected by the service provider from among the generated instances, and may provide the service provider with information about the analyzed instance state through the website.

The cloud service system may output a list of at least one instance selected by the service provider, and may provide information about a state of the output of at least one instance as a graph. The cloud service system may provide an interface for transmitting an e-mail or an SMS to an alarm receiver when the analyzed instance state exceeds a predetermined threshold, and may output the transmitted e-mail or an SMS list through the website when the analyzed instance state exceeds the threshold.

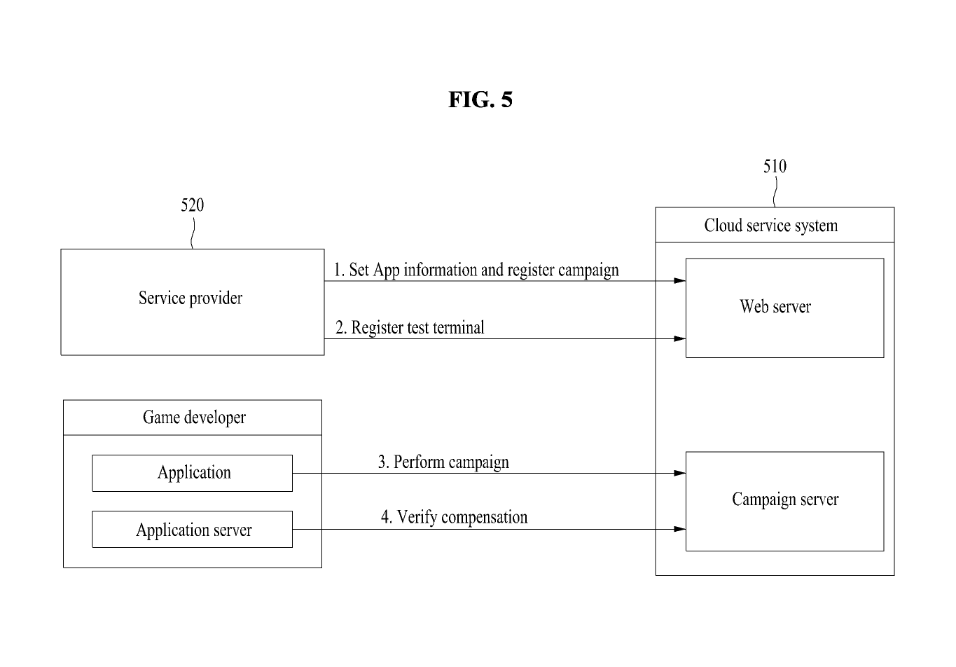

FIG. 5 illustrates an operation of a cloud service system to provide a campaign according to an exemplary embodiment.

The cloud service system 510 may include a web server to provide a website to a service provider 520, and may also include a campaign server to provide a campaign to a terminal in which an application is installed. The cloud service system 510 may provide the service provider 520 with the website that provides the service provider interface. The service provider 520 may register an application by inputting information about the application through the website. The cloud service system 510 may provide a plurality of campaign templates to the service provider 520, and may generate a campaign for the registered application by inputting campaign information input from the service provider 520 into items of a campaign template selected by the service provider 520 from the plurality of campaign templates. The service provider 520 may, for example, register a test terminal for testing the generated campaign.

The cloud service system 510 may provide the generated campaign to at least a portion of user terminals in which the registered application is installed. For example, the cloud service system 510 may target at least a portion of user terminals based on a type of the campaign template selected by the service provider 520, and may provide the generated campaign to the targeted user terminals. The campaign may be performed by the user on the terminal having received the campaign.

A campaign mission may be accomplished by the user. In this case, an application server may transfer the accomplishment of the campaign mission to the cloud service system 510. The cloud service system 510 may monitor that the camping mission has been accomplished, using a predetermined accomplishment value. When the campaign mission is accomplished, the cloud service system 510 may provide compensation based on a compensation type and a compensation value.

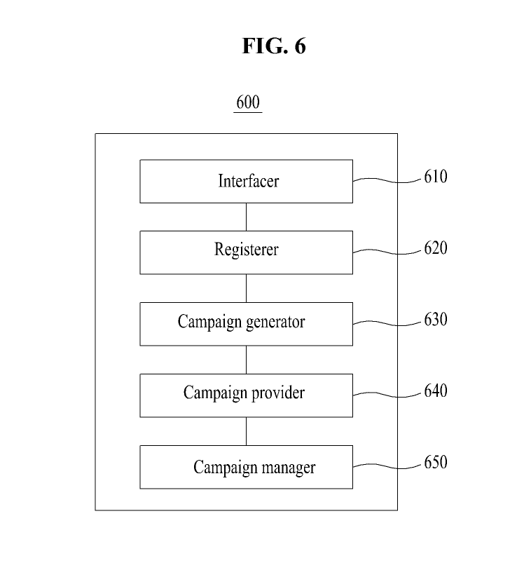

FIG. 6 is a block diagram illustrating a configuration of a cloud service system to provide a campaign according to an exemplary embodiment.

Referring to FIG. 6, the cloud service system 600 refers to a system to provide a campaign to a user terminal, and may include, for example, an interfacer 610, a registerer 620, a campaign generator 630, a campaign provider 640, and a campaign manager 650.

The interfacer 610 may provide a service provider with a website that provides a service provider interface. The cloud service system 600 provides the service provider with the website that provides the service provider interface and accordingly, the service provider may generate a campaign through the website.

The registerer 620 may register the application in response to receiving information about the application from the service provider through the website.

The campaign generator 630 may provide a plurality of campaign templates to the service provider, may input campaign information input from the service provider into items of a campaign template selected by the service provider, and may generate a campaign for the registered application. The campaign generator 630 may display different types of campaign templates to the service provider through the website. For example, the campaign generator 630 may display at least two campaign templates among, for example, an early leave preventing template, a leave risk care template, a first purchase inducement template, a repurchase inducement template, and a return inducement template to the service provider through the website.

The campaign generator 630 may display information about predetermined campaign goals and may also display campaign templates classified for a campaign goal selected by the service provider, through the website.

The campaign generator 630 may verify whether at least one campaign to be provided to the registered application is generated in advance. For example, when at least one campaign to be provided to the registered application is not generated in advance, a campaign may be directly generated by the service provider.

The campaign generator 630 may provide the service provider with an interface for receiving campaign information for each item of the selected campaign template from the service provider through the website, and may generate the campaign using a campaign template in which campaign information is input into each item. For example, items of the selected campaign template may include at least two items among a campaign name, a campaign target, a campaign schedule, a platform to perform a campaign, a country in which the campaign is to be performed, a campaign display method, a push use for the campaign, providing of compensation, and compensation details.

Through the website, the campaign generator 630 may provide an interface for receiving a campaign mission to be carried out, an accomplishment value preset for accomplishing the campaign mission, a type of compensation to be provided in response to accomplishing the campaign mission, and a compensation value to be provided. The campaign generator 630 may monitor that the campaign mission has been accomplished, using the accomplishment value, and in response to accomplishment of the campaign mission, may provide compensation based on a compensation type and a compensation value.

The campaign generator 630 may select a campaign display method including at least one of a pop-up and a banner selected by the service provider, through the website. When the pop-up is selected by the service provider, the campaign generator 630 may provide an interface for receiving a campaign image, a compensation image, a campaign display location in an application and an iterative campaign display. When the banner is selected by the service provider, the campaign generator 630 may provide an interface for receiving a campaign image, a compensation image, and a campaign display location in an application.

The campaign generator 630 may output a list of campaigns generated by the service provider. Each of the generated campaigns may include at least two of a campaign name, a campaign display method, a campaign period, a state of a generated campaign, edition of the campaign, and analysis information of the campaign.

The campaign generator 630 may provide an interface for performing a campaign progress test or a push send test with respect to a campaign of which a registration is completed by the service provider among campaigns included in the output list.

The campaign provider 640 may provide the generated campaign to at least a portion of user terminals in which the registered application is installed. The campaign provider 640 may target at least a portion of user terminals based on a type of a campaign template selected by the service provider and may provide the generated campaign to the targeted user terminals.

The campaign provider 640 may push a campaign to a targeted user terminal based on information about a campaign providing time included in campaign information received for each item of the selected campaign template.

When at least one campaign is generated in advance, the campaign provider 640 may transmit a campaign selected by the service provider from among the at least one campaign to at least a portion of the user terminals.

The campaign manager 650 may classify and thereby manage campaign templates generated by analyzing campaigns provided to users during a predetermined period of time, for each campaign goal. The campaign manager 650 may classify and thereby manage the generated campaign templates for at least two campaign goals among an early leave preventing goal, a leave risk care goal, an item purchase inducement goal, an item repurchase inducement goal, and a user return inducement goal.

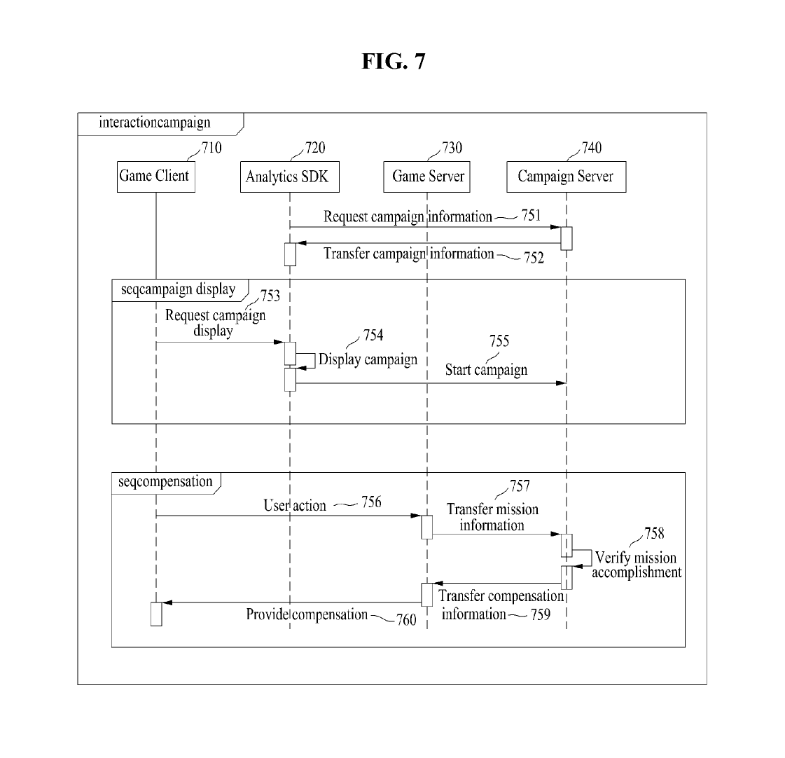

FIG. 7 illustrates a process of providing a campaign at a cloud service system according to an exemplary embodiment.

The cloud service system may generate a campaign through a service provider. For example, the cloud service system may provide the service provider with a website that provides a service provider interface. The service provider may input information about an application and may register the application based on the input information through the website. The service provider may generate the campaign using a campaign template and may set whether to provide compensation in response to a mission accomplishment.

A process of providing a campaign to a user terminal in which an application is installed through operations among the application, and an application server, and a campaign server 740 will be described with reference to FIG. 7. For example, when a game application is installed in a user terminal, the game application may be operated by a game server 730.

A game client 710 may be, for example, a game application. When a terminal in which the application is installed is a targeted terminal, an analytics software development kit (SDK) 720 may request the campaign server 740 for campaign information in operation 751. The campaign server 740 may transfer the campaign information to the analytics SDK 720 in operation 752.

When the game application requests campaign display in operation 753, the analytics SDK 720 may display a campaign to the terminal in which the game application is installed based on campaign information received from the campaign server 740 in operation 754, and may start the campaign by displaying the campaign in operation 755.

A user using the game application may take an action for the displayed campaign in operation 756, and the game server 730 may detect the user action. The game server 730 may transfer mission information input from the user to the campaign server 740 in operation 757, and may verify whether a mission has been accomplished by verifying predetermined mission and compensation provided in operation 758. When the mission is verified to have been accomplished, the campaign server 740 may transfer compensation information to the game server 730 in operation 759. For example, compensation information may indicate a type of compensation to be provided and a compensation value when the user using the game application accomplishes the mission. The game server 730 may provide compensation to the game application based on compensation information in operation 760. Here, providing of the compensation may include, for example, providing an item, upgrading a level, and providing game money.

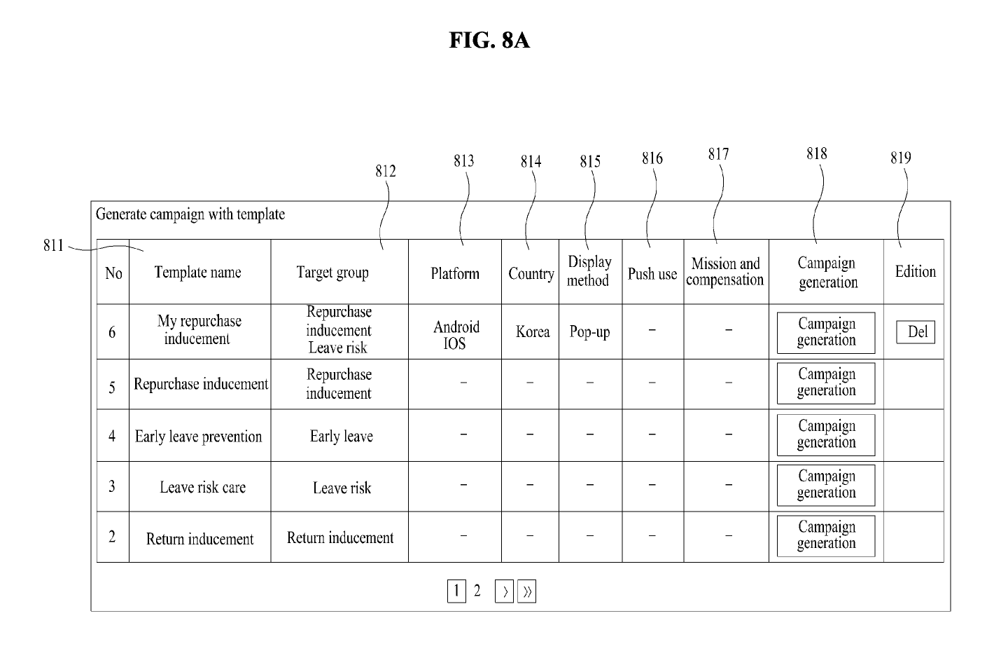

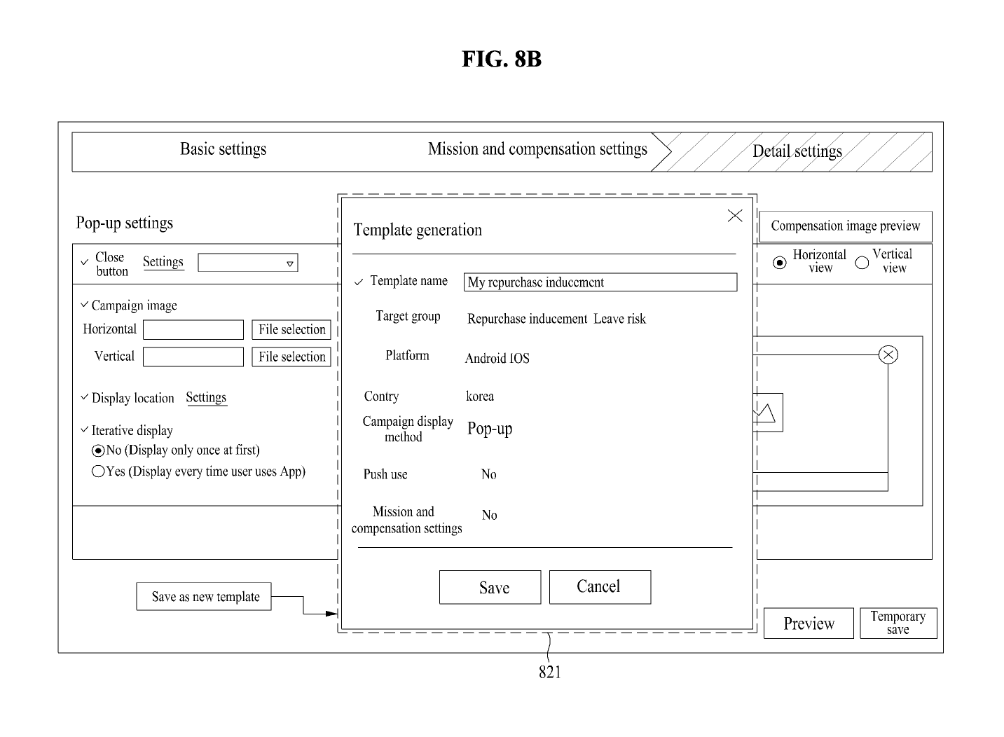

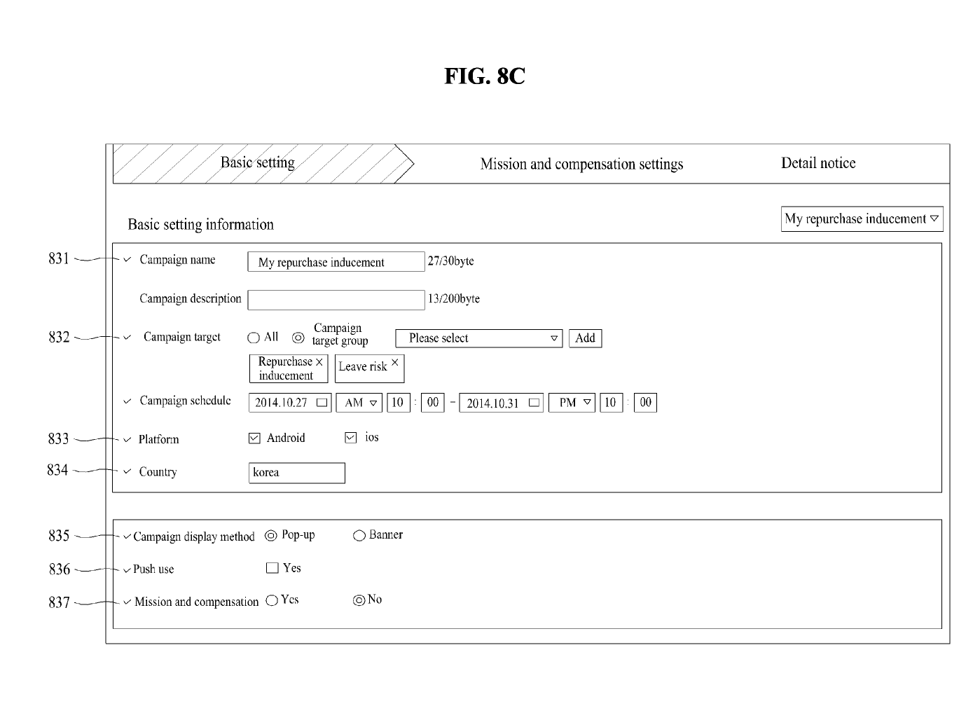

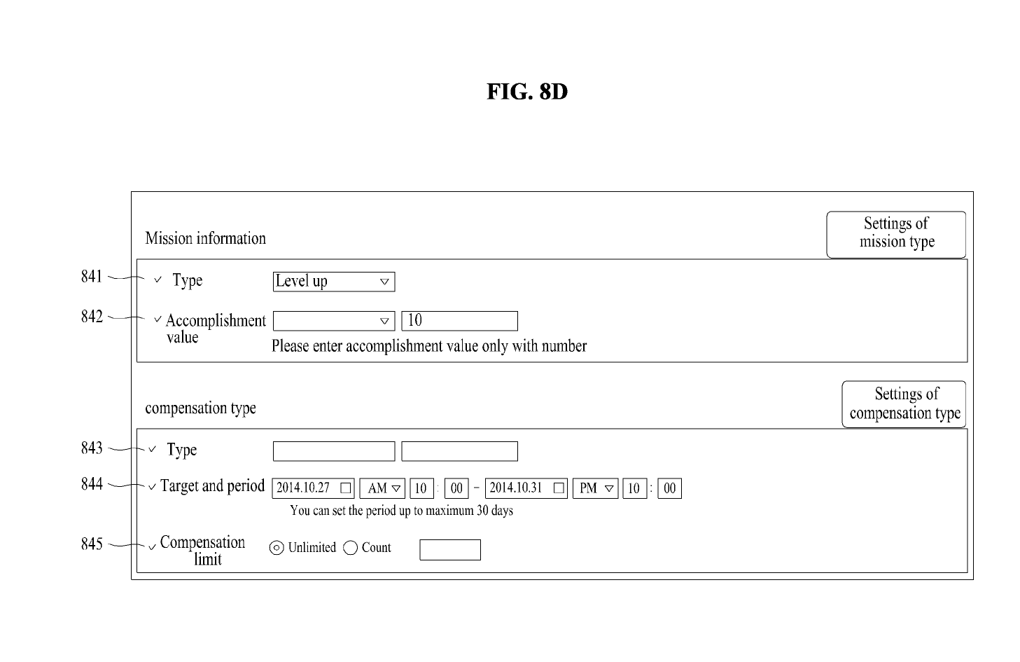

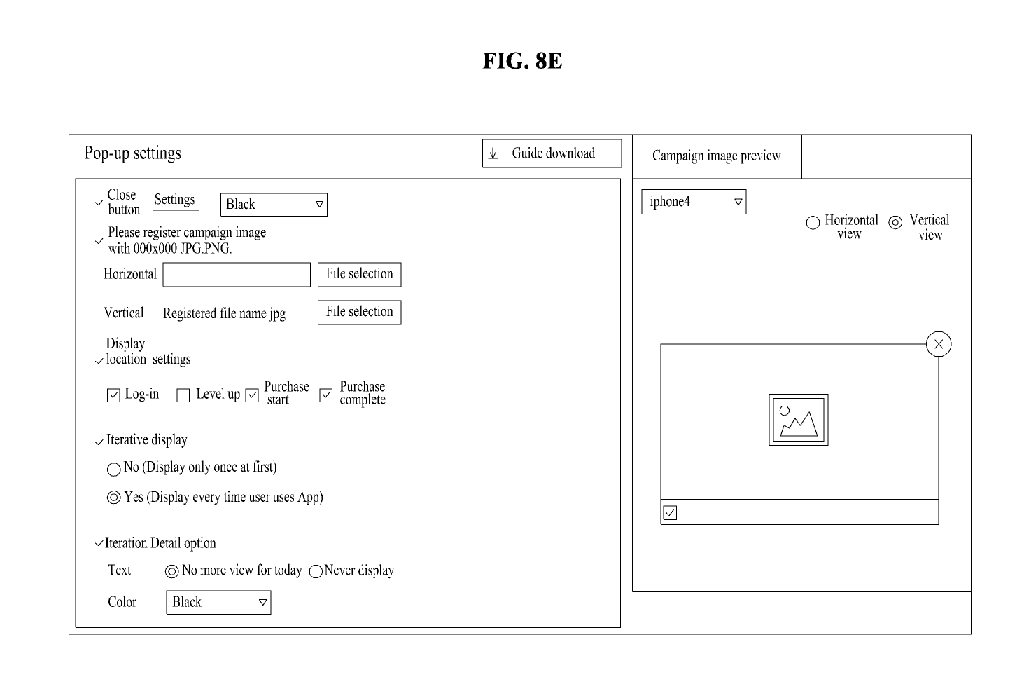

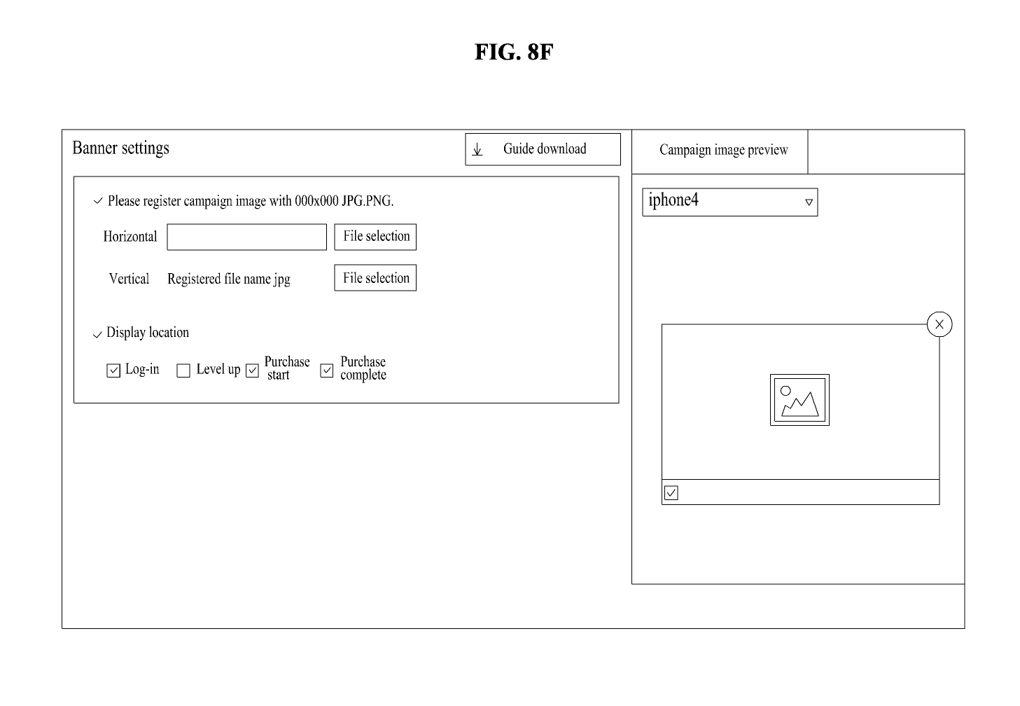

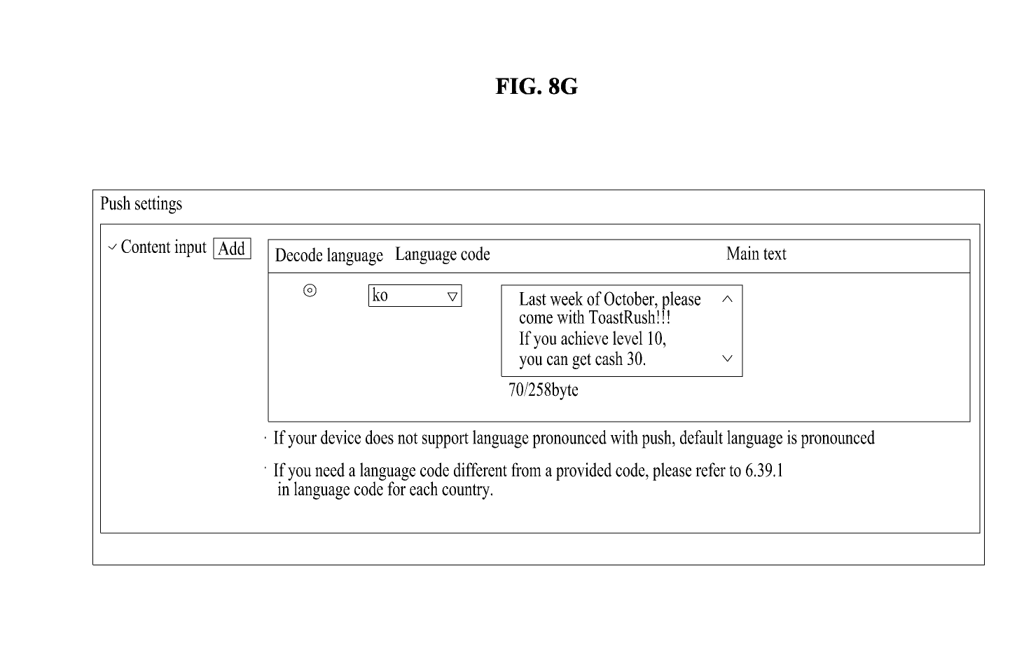

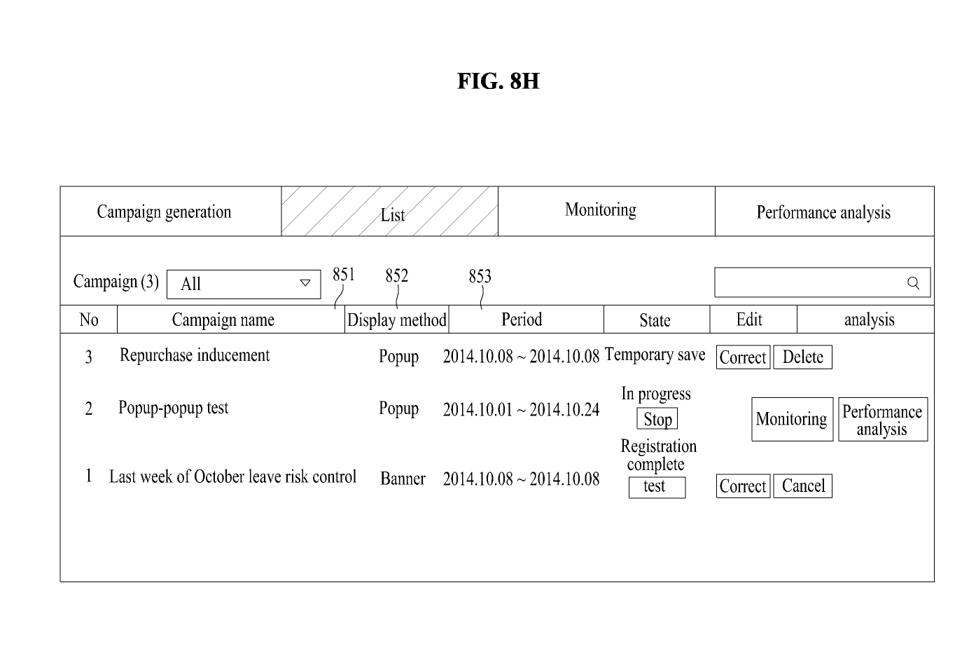

FIGS. 8A through 8H illustrate examples of an interface for constructing an infrastructure service at a cloud service system according to an exemplary embodiment.

The cloud service system may provide a service provider with a website that provides a service provider interface. An application may be registered in response to information about the application input from the service provider through the website.

Campaign templates generated by analyzing campaigns provided to users during a predetermined period of time may be classified and thereby managed for each campaign goal. Through the website, information about the predetermined campaign goals may be displayed to the service provider and campaign templates classified for a campaign goal selected by the service provider may be displayed. For example, the generated campaign templates may include an early leave preventing goal of users, a goal for managing a user that is likely to leave, an item purchase inducement goal, an item repurchase inducement goal, and a user return inducement goal.

Referring to FIG. 8A, the cloud service system may provide a plurality of campaign templates to the service provider, and the service provider may select at least one campaign template from among the plurality of campaign templates. For example, the cloud service system may display at least two campaign templates among an early leave preventing template, a leave risk care template, an initial purchase inducement template, a repurchase inducement template, and a return inducement template to the service provider through the website. For example, information about a campaign template to be displayed through the website may include a template name 811, a target group 812 to which a campaign is to be performed, a platform 813 to perform the campaign, a country 814 in which the campaign is to be performed, a campaign display method 815, a push use 816 for the campaign, and a mission and compensation 817. When a campaign is to be generated from the generated campaign template, the service provider may generate the campaign by selecting a campaign generation button of a campaign generation field 818 and may delete a campaign template through an edition button of an edition field 819.

Referring to FIG. 8B, the service provider may generate a campaign for a registered application. For example, the service provider may generate a new campaign template. When a template that the service provider is to generate is absent, the service provider may store a new template 821 by inputting information for generating the template into a template generation interface.

Referring to FIG. 8C, when the service provider selects at least one campaign template from among a plurality of campaign templates, the service provider may generate a campaign by inputting campaign information into items of the selected campaign template. For example, the service provider may generate a campaign by inputting at least two items among a campaign name 831, a campaign target 832, a campaign schedule, a platform 833 to perform the campaign, a country 834 in which the campaign is to be performed, a campaign display method 835, a push use 836 of the campaign, and a mission and compensation 837.

Referring to FIG. 8D, the cloud service system may provide an interface for receiving a campaign mission to be carried out, an accomplishment value preset for accomplishing the campaign mission, a type of compensation to be provided in response to accomplishing the campaign mission, and a compensation value to be provided, through the website. The service provider may set criteria about a mission and compensation by inputting a type 841 of a mission, an accomplishment value 842 for accomplishing the mission, a type 843 of compensation, a target and period 844 for providing compensation, and a compensation limit 845.

The cloud service system may monitor whether a terminal in which an application is installed has accomplished the campaign mission using a predetermined accomplishment value, and may provide compensation to the application based on a compensation type and a compensation value when the campaign mission is accomplished.

Referring to FIGS. 8E and 8F, the cloud service system may provide an interface for receiving a campaign display method including at least one of a pop-up interface and a banner interface through the website. Referring to FIG. 8E, the cloud service system may provide a pop-up interface for receiving a campaign image, a compensation image, a campaign display location in an application, and an iterative campaign display. When the service provider selects the pop-up, the service provider may input the campaign image, the compensation image, the campaign display location in the application, and the iterative campaign display.

Referring to FIG. 8F, the cloud service system may provide a banner interface for receiving a campaign image, a compensation image, and a campaign display location in an application. When the service provider selects a banner, the service provider may input the campaign image, the compensation image, and the campaign display location in the application. Also, the pop-up interface and the banner interface may provide a preview function capable of verifying a campaign generated based on information input from the service provider. Referring to FIG. 8G, the service provider may input message content for sending a push notification to a terminal in which a registered application is installed. Here, the message content may be transmitted to the terminal in which the application is installed.

Referring to FIG. 8H, a list of campaigns generated by the service provider may be output. Each of the generated campaigns may include, for example, at least one of a campaign name 851, a campaign display method 852, a campaign period 853, a state of a generated campaign, an edition of the campaign, and analysis information of the campaign. A campaign progress test or a push send test may be performed with respect to a campaign of which a registration is completed by the service provider among campaigns included in the output list.

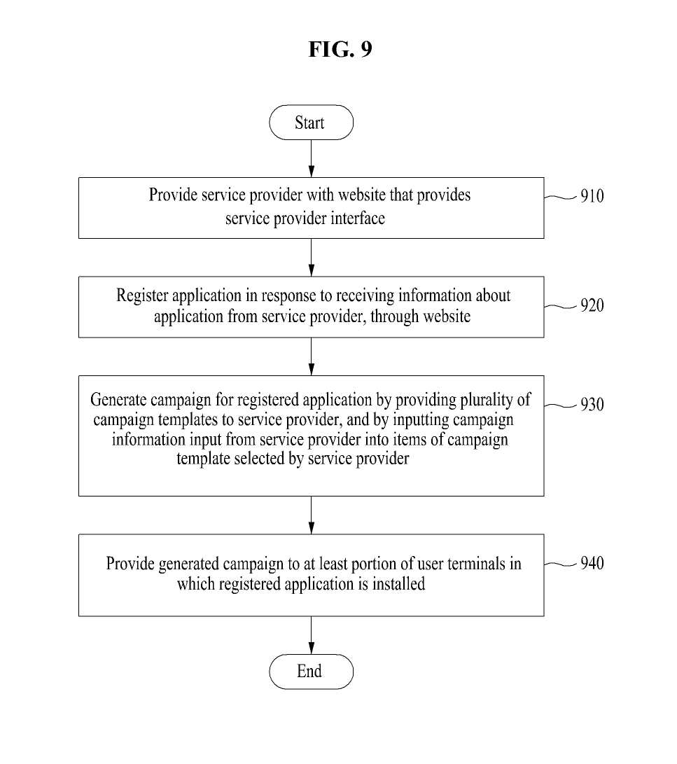

FIG. 9 is a flowchart illustrating a cloud service method of a cloud service system to provide a campaign according to an exemplary embodiment.

In operation 910, the cloud service system may provide a service provider with a website that provides a service provider interface.

In operation 920, the cloud service system may register an application in response to receiving information about the application from the service provider, through the website.

In operation 930, the cloud service system may generate a campaign for the registered application by providing a plurality of campaign templates to the service provider, and by inputting campaign information input from the service provider into items of a campaign template selected by the service provider. Here, the plurality of campaign templates may include an early leave preventing template, a leave risk care template, an initial purchase inducement template, a repurchase inducement template, and a return inducement template.

In operation 940, the cloud service system may provide the generated campaign to at least a portion of user terminals in which the registered application is installed. The cloud service system may target at least a portion of the user terminals based on a type of a campaign template selected by the service provider and may provide the generated campaign to a targeted user terminal. The cloud service system may push the campaign to the targeted user terminal based on information about a campaign providing time included in campaign information received for each item of the selected campaign template.

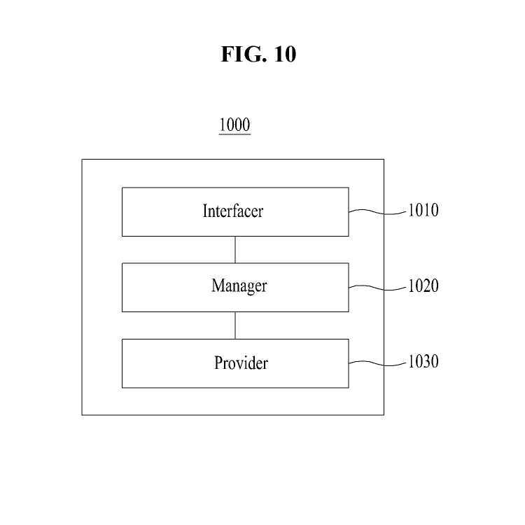

FIG. 10 is a block diagram illustrating a configuration of a cloud service system to provide initial information according to an exemplary embodiment.

Referring to FIG. 10, the cloud service system 1000 refers to a system for providing initial information including launching information to a terminal, and may include an interfacer 1010, a manager 1020, and a provider 1030.

The interfacer 1010 may provide a service provider with a website that provides a service provider interface. The cloud service system 1000 may provide the service provider with the website that provides the service provider interface and accordingly, the service provider may generate initial information through the website.

The manager 1020 may update and manage launching information by receiving alterations of the launching information from the service provider through the website. For example, the launching information may include initial information used for a service terminal to receive a service from the service provider.

The manager 1020 may provide an interface for generating a parameter to an application, and may generate a parameter for providing information based on parameter information input from the service provider.

The manager 1020 may generate a template by providing a template sample interface including a plurality of templates to add a template, and by receiving a selection on at least one of the templates from the service provider.

The manager 1020 may output information about a group by providing an interface for setting the group with respect to generated at least one template and by referring to the group input from the service provider.

The manager 1020 may output information about a member by providing an interface for setting a member included in a set group with respect to at least one template and by referring to the member input from the service provider.

The manager 1020 may provide an interface for correcting/deleting a group and a member included in the group, may correct/delete the group input from the service provider and the member included in the group, and may output the corrected/deleted group and member.

The manager 1020 may provide a logic definition interface for defining launching information, may generate launching information input from the service provider, and may output alterations of the launching information in response to the launching information being altered.

When an application is executed at the service terminal, the provider 1030 may provide initial information including updated launching information to the service terminal. For example, the initial information may include information used to connect to a server of the service provider. The service terminal may connect to the server of the service provider using initial information received from the cloud service system at the execution of the application.

The provider 1030 may provide an interface that may output previously distributed launching information and restore the launching information previously distributed from the service provider, and renew output of the previously distributed launching information again.

The provider 1030 may publish a message including an application inspection schedule or an event during a period of time set by the service provider, and may stop a service and publish an inspection message during the set period of time.

The provider 1030 may provide at least one function selected by the service provider from among a function of notifying upgrade of a previous version of an application, a function of forcefully updating an application, and a function of disallowing an access of a previous version application.

When a service error occurs due to a specific user terminal or an OS version upgrade, the provider 1030 may limit a service against a user terminal in which the service error is to occur or a user terminal including an upgraded OS version.

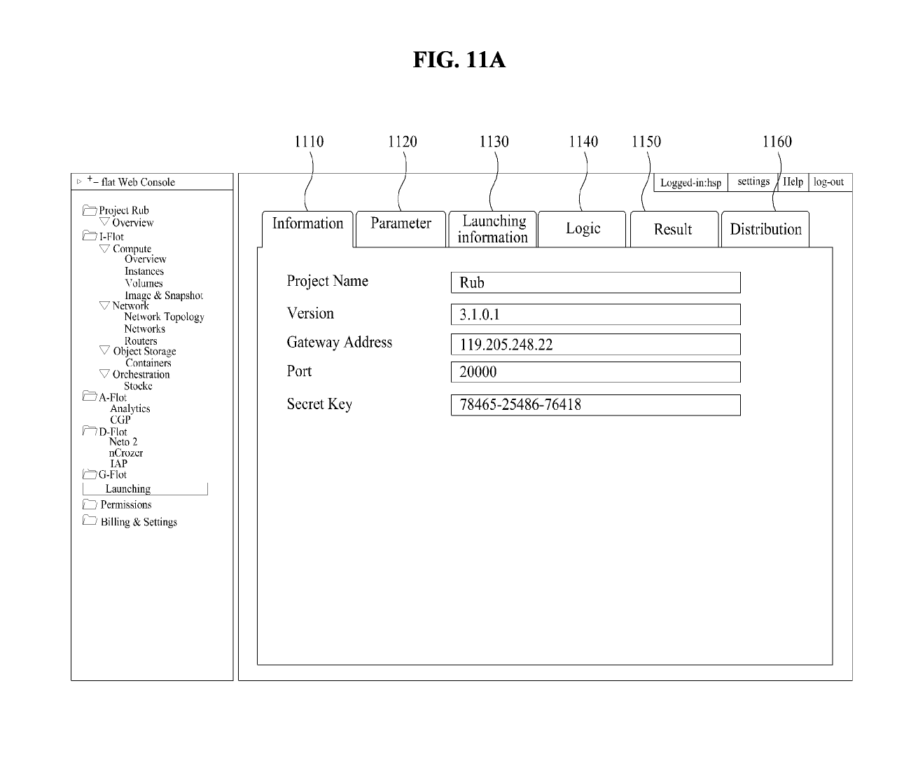

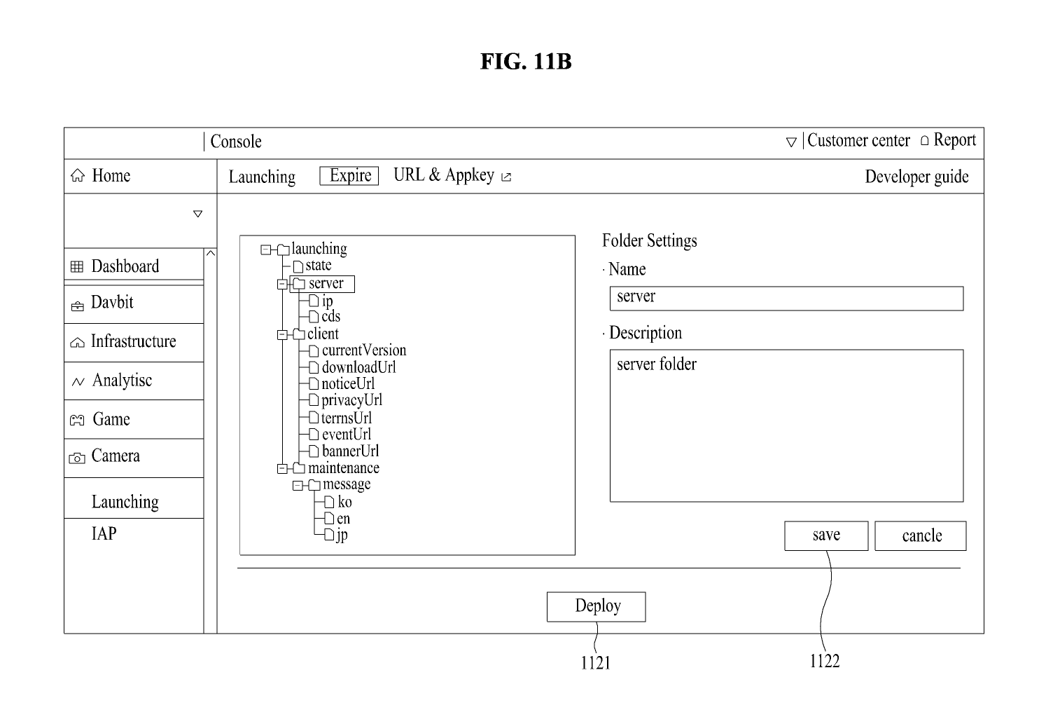

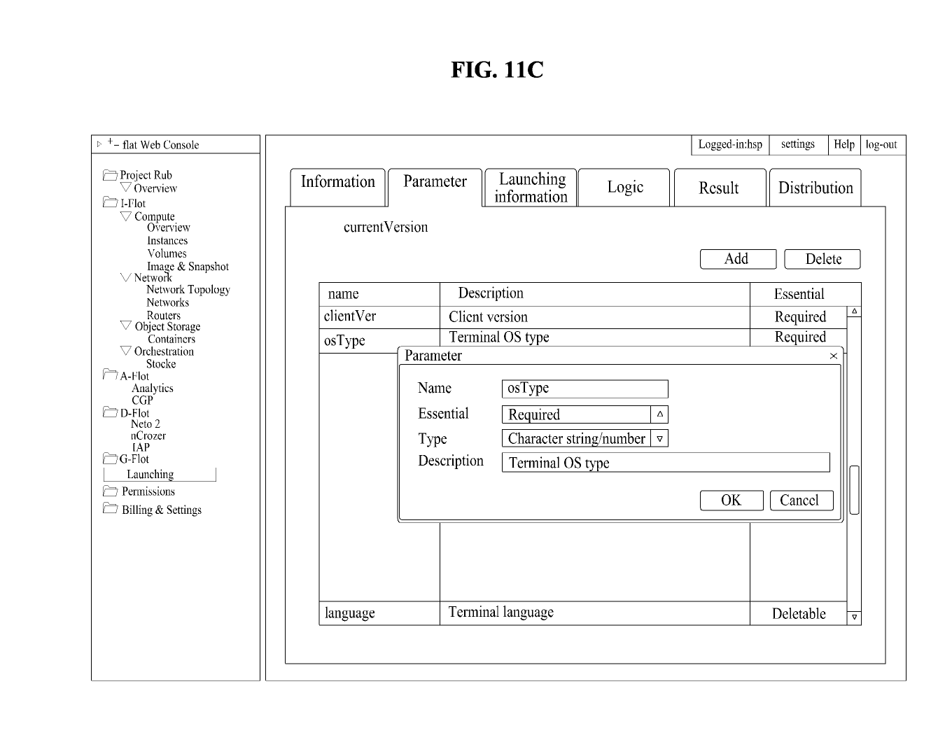

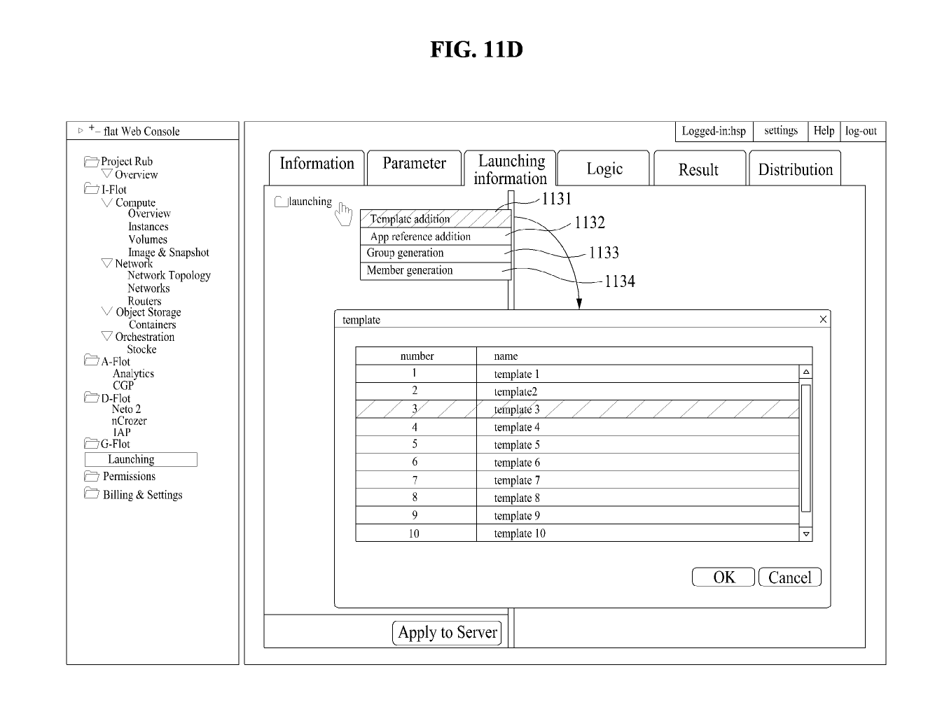

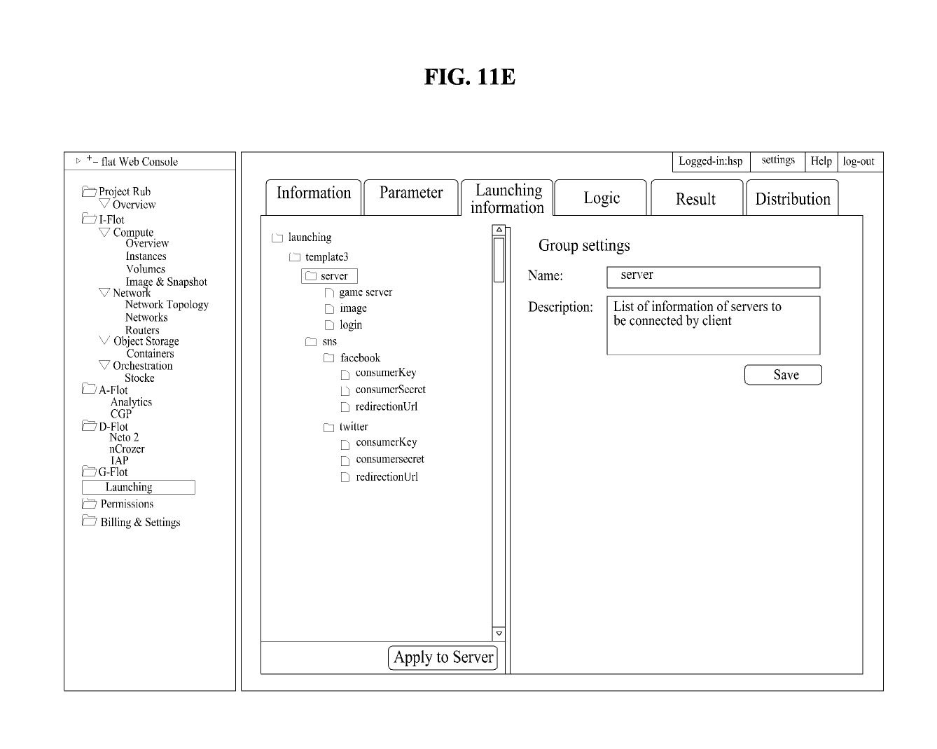

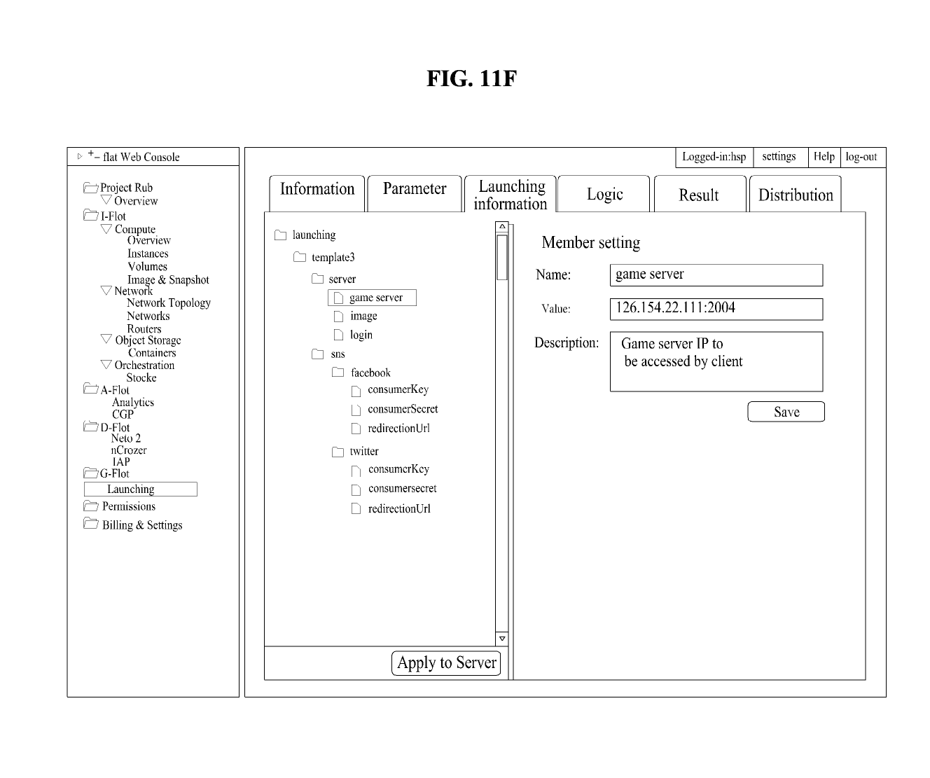

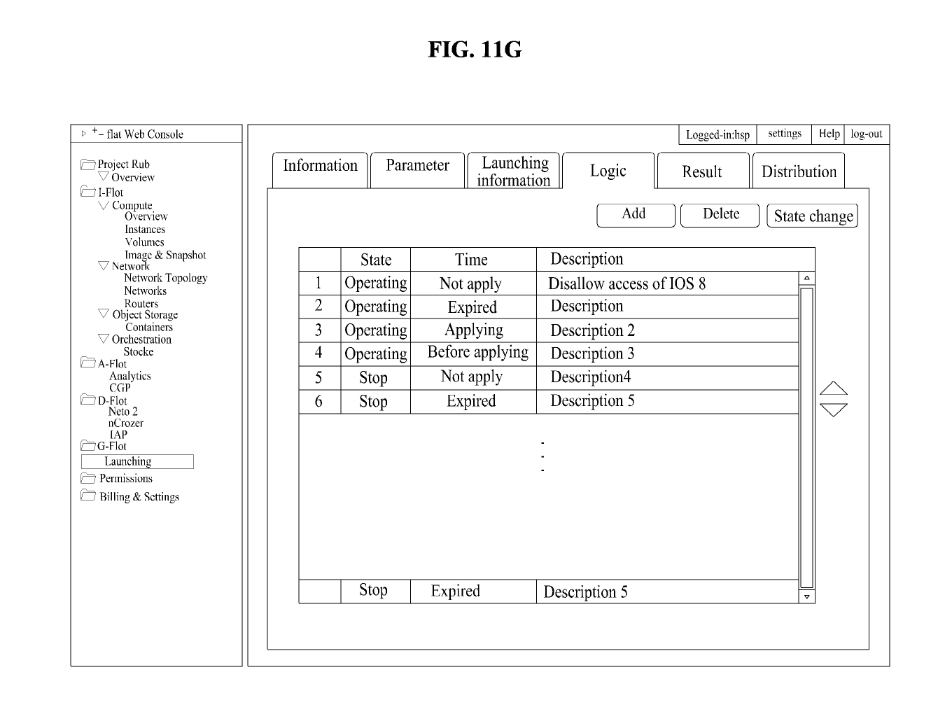

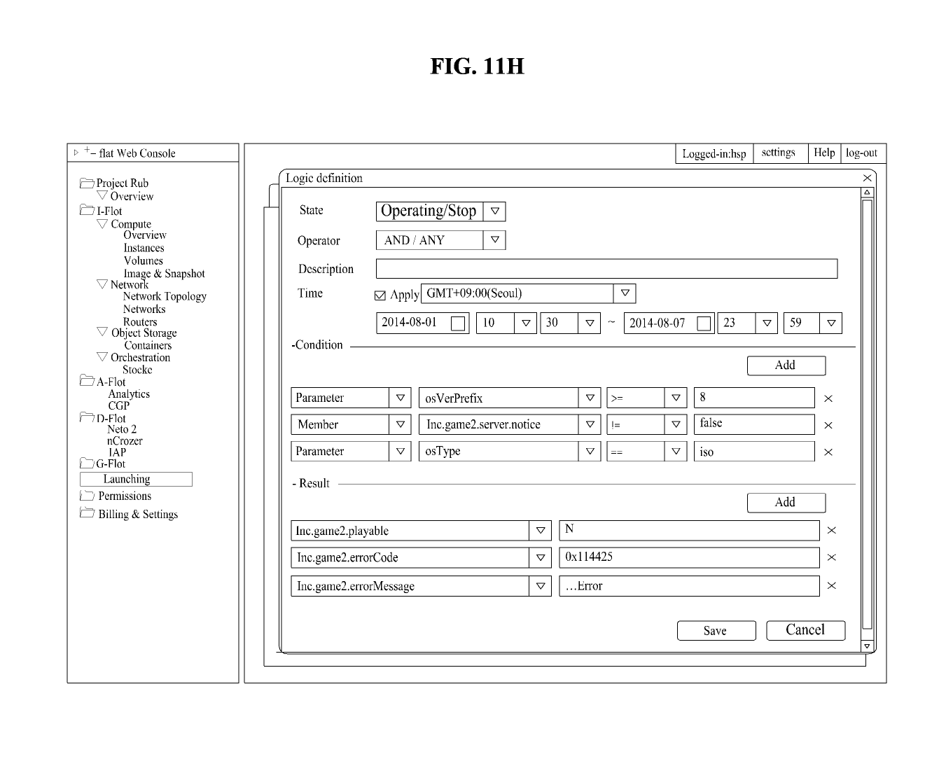

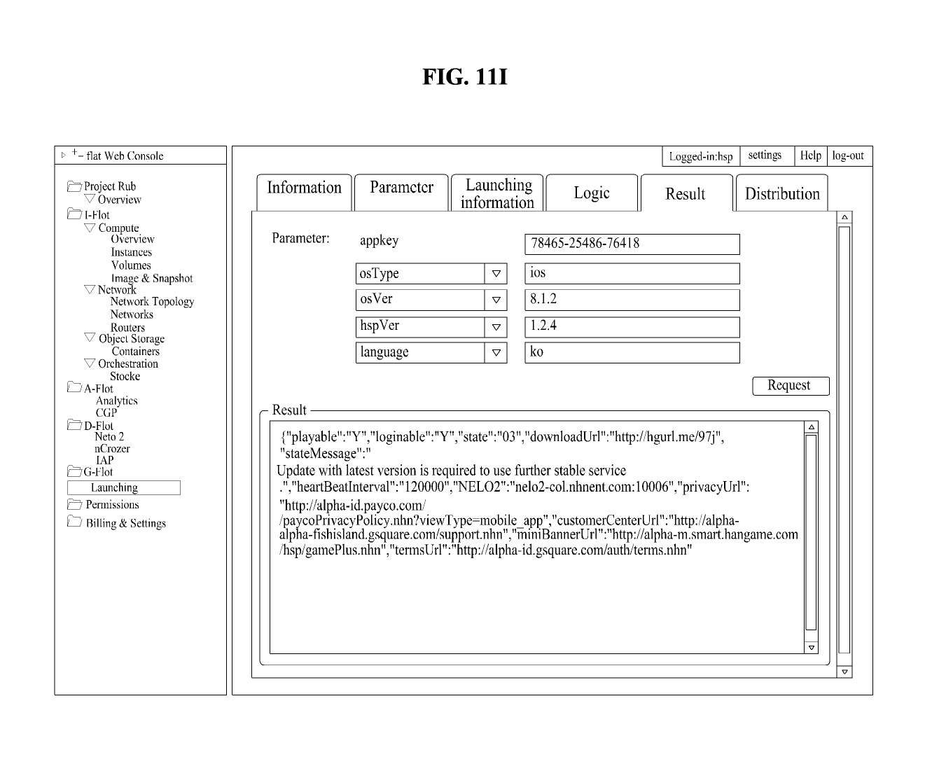

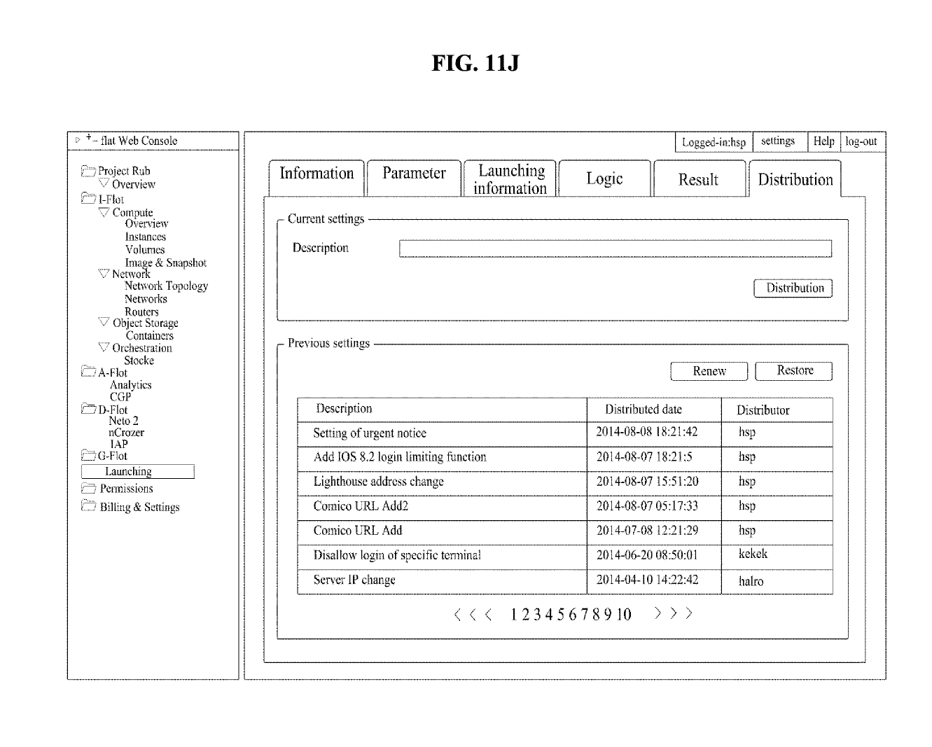

FIG. 11A through 11J illustrate examples of an interface for providing initial information at a cloud service system according to an exemplary embodiment.

The cloud service system may provide a service provider with a website that provides a service provider interface. Referring to FIG. 11A, the cloud service system may provide an information tab 1110, a parameter tab 1120, a launching information tab 1130, a logic tab 1140, a result tab 1150, and a distribution tab 1160 through the website. When the service provider generates a project, a project name, a version, a gateway address, and a port number, a secret key may be output on the information tab 1110 and currently set initial information may be output. For example, application name “rub”, version “3.1.0.1”, gateway address “119.205.248.22”, port number “20000”, and secret key “78465-25486-76418” may be output on the information tab 1110.

Referring to FIG. 11B, the cloud service system may provide an interface capable of referring to currently set initial information through the website, and the service provider may refer to initial information. The cloud service system may output information about a folder selected by the service provider through the website, may change a name and description of the selected folder, and may store the changed name and description of the folder by clicking on a save button 1122. For example, modified matters may be applied to a server by clicking on a deploy button 1121.

Further, when the service provider selects a folder and clicks on a right mouse at the website, an interface for adding a folder, an interface for adding a key, and an interface for deleting a folder or a key may be provided. For example, when the service provider selects an add folder to add a folder, the folder may be added.

When the service provider selects a key at the website, information about the key may be output and the service provider may change a name and a key value of the selected key. The service provider may add a key through the interface for adding the key. The service provider may select a folder or a key and then may delete the folder or the key through the interface for deleting the folder or the key. Similarly, the service provider may temporarily store altered information by clicking on the save button 1122, and may apply the alterations to a server by clicking on the deploy button 1121.

Referring to FIG. 11C, the cloud service system may provide an interface for generating a parameter to an application through the website, and the service provider may generate a parameter for providing initial information by inputting parameter information. The generated parameter may be output on a parameter tab.

Referring to FIG. 11D, the cloud service system may provide a template addition interface 1131, an App reference addition interface 1132, a group generation interface 1133, and a member generation interface 1134 with respect to a project generated on a launching information tab of the website. To add a template, the service provider may click on a template addition button. For example, the cloud service system may provide a plurality of template samples through the website, and the service provider may add a template by selecting at least one template from among the plurality of template samples.

Referring to FIG. 11E, the cloud service system may provide an interface for referring to a group and setting the group through the website. The service provider may refer to and set a group through the provided interface. The service provider may correct and thereby store a name and description of the group. To add a group, the service provider may generate the group by selecting the group generation interface 1133 of FIG. 11D, and may set information about the generated group by inputting a name and description of the generated group.

Referring to FIG. 11F, the cloud service system may provide an interface for referring to and setting a member through the website. The service provider may refer to and thereby set a member through the provided interface. The service provider may correct and thereby store a name and description of the member. To add a member, the service provider may generate the member by selecting the member generation interface 1134 of FIG. 11D, and may set information about the generated member by inputting a name, a value, and description of the generated member.

Referring to FIG. 11G, the cloud service system may provide a list including a state, a time, and description of defined launching information. The cloud service system may provide an interface for adding/deleting launching information and altering a state of the launching information. The service provider may add/delete the launching information, and may alter the state of the launching information through the provided interface.

Referring to FIG. 11H, the cloud service system may provide a logic definition interface for defining launching information through the website. The service provider may generate launching information by inputting and storing, for example, a condition and a result through the logic definition interface.

Referring to FIG. 11I, the cloud service system may provide a terminal with initial information including launching information updated in response to an input of a service provider based on a generated parameter through the website, and may output a result of transmitting the initial information including the updated launching information to the terminal.

Referring to FIG. 11J, the cloud service system may provide an interface for distributing initial information including updated launching information through the website. The service provider may distribute the initial information including the updated launching information to a terminal by inputting description about the initial information.

The cloud service system may output a launching information list including previously distributed launching information, and may provide an interface for restoring previously distributed launching information and an interface including a renewing function of outputting the previously distributed launching information again. The service provider may restore the previously distributed launching information through the provided interface and may output the previously distributed launching information at a current point in time again.

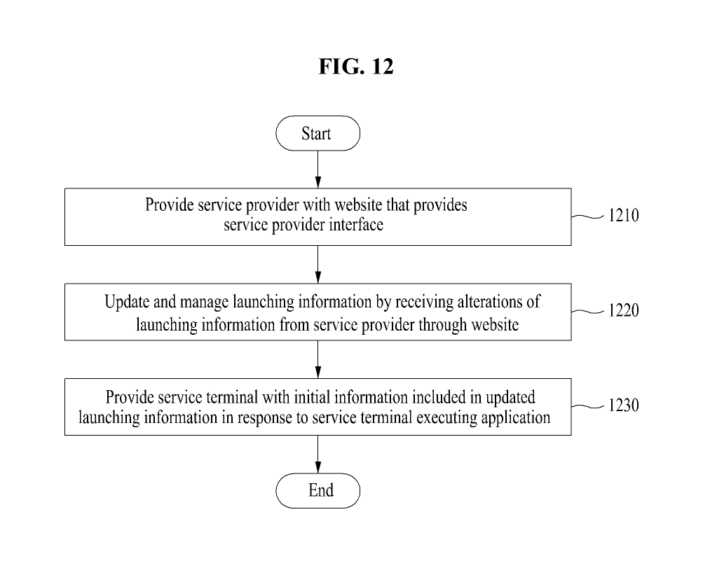

FIG. 12 is a flowchart illustrating a cloud service method of a cloud service system to provide initial information according to an exemplary embodiment.

In operation 1210, the cloud service system may provide a service provider with a website that provides a service provider interface.

In operation 1220, the cloud service system may update and manage launching information by receiving alterations of the launching information from the service provider through the website. For example, the launching information may include initial information used for a service terminal provided with a service from the service provider to execute an application for receiving the service.

In operation 1230, the cloud service system may provide the service terminal with initial information included in the updated launching information in response to the service terminal executing the application. The initial information may include information used to connect to a server of the service provider. The service terminal may connect to the server of the service provider using the initial information received from the cloud service system.

The cloud service system may output previously distributed launching information. Also, the cloud service system may publish a message including an inspection schedule of the application or an event during a predetermined period of time set by the service provider, and may stop the service and publish an inspection message during the period of time set by the service provider.

The cloud service system may provide at least one function among a function of notifying upgrade of a previous version of an application, a function of forcefully updating an application, and a function of disallowing an access of a previous version application.

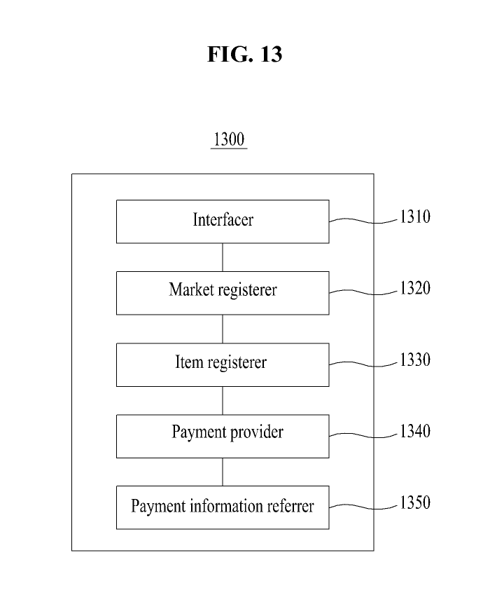

FIG. 13 is a block diagram illustrating a configuration of a cloud service system to provide an integrated payment service according to an exemplary embodiment.

Referring to FIG. 13, the cloud service system 1300 refers to a system for providing an integrated payment service, and may include an interfacer 1310, a market registerer 1320, an item registerer 1330, a payment provider 1340, and a payment information referrer 1350.

The interfacer 1310 may provide a service provider with a website that provides a service provider interface. The cloud service system 1300 may provide an integrated payment service to a terminal in which an application is installed by providing the service user with the website that provides the service provider interface.

The market registerer 1320 may receive an application key value corresponding to at least one online application store among application key values issued from a plurality of online application stores. The market registerer 1320 may register the issued application key value and information for interaction with an online application store, input from the service provider, through the website.

The market registerer 1320 may output an online application store list including information for interaction with the online application store input from the service provider. For example, information for interaction with the online application store may include at least one of an ID of an application for interaction with the online application store, an application name, a package name of an application registered to the online application store, a state of an online application, and a registration date on which the online application store is registered.

The item registerer 1330 may register an item for the application based on information for interaction with the registered online application store.

The payment provider 1340 may provide the terminal in which the application is installed with a single interface generated using a payment API for providing an integrated payment service in response to a request for payment for at least one item among registered items from the application. The single interface may control the terminal to process at least one integrated payment service among a payment request for an item from an online application store, a payment verification request for determining whether the payment for the item is accurately performed from the online application store, and a payment details reference request for referring to payment details of the item.

The payment provider 1340 may determine whether the requested payment for the item is performed, may inspect the payment validity using a payment purchase token for maintaining a security, and may transfer the purchased item to the application in response to completing the requested payment for the item. In this example, when the requested payment for the item is not performed, the payment provider 1340 may provide an interface for referring to unused payment details for verifying whether the payment for the item is completed, through the website.

The payment information referrer 1350 may provide a payment information reference interface for outputting payment details for a registered item through the website. The payment information referrer 1350 may select an ID of a market from information for interaction with the online application store and may input a start date and an end date for verifying payment information about the ID of the market through the website. In response thereto, payment information details may be output. Here, the payment information details may include at least one of an application ID, an ID of a market, an ID of a user, an ID of an item, a key value of an application, a payment state of the item, a price of the item, a payment date of the item, and a refund date of the item. The payment state of the item may include at least one of a payment in progress, a payment success, and a payment failure.

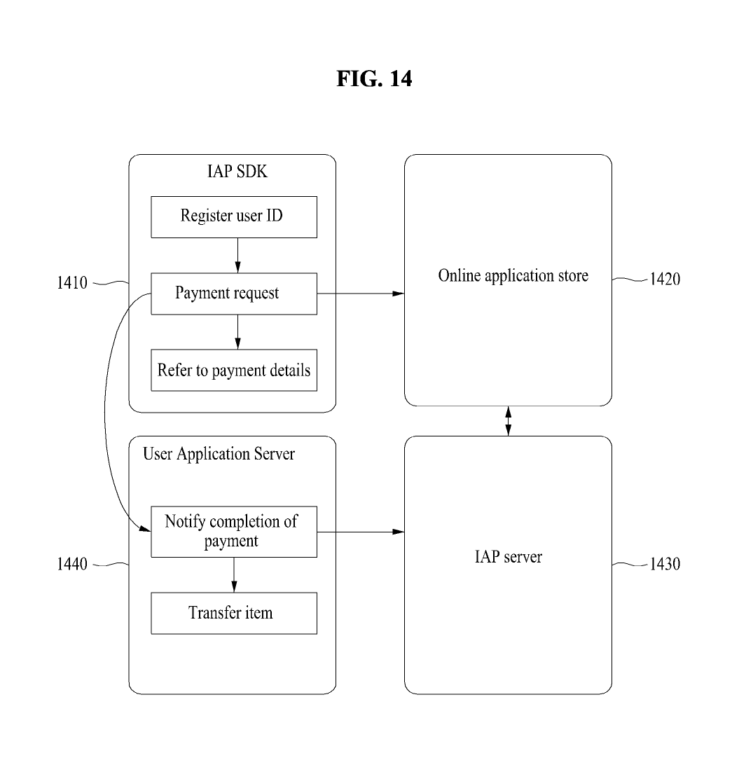

FIG. 14 illustrates an operation of a cloud service system to provide an integrated payment service according to an exemplary embodiment.

The cloud service system, as a system for providing in-App purchase (IAP), may provide a terminal with a single interface for providing an integrated payment service in interaction with, for example, a plurality of online application stores. An online application store 1420 may be a market application such as, for example, Google Play and App Store. The cloud service system may perform payment through twice or three times of API calling using an IAP SDK 1410.

Hereinafter, a process of performing an integrated payment service through operations of the IAP SDK 1410, the online application store 1420, an IAP server 1430, and a user application server 1440 will be described with reference to FIG. 14. The cloud service system may receive an application key value corresponding to at least one online application store among application key values issued from a plurality of online application stores, and may register the issued application key value and information for interaction with an online application store, input from a service provider, through a website. The cloud service system may register an item for the application based on the registered information for interaction with the online application store.

A terminal in which an application is installed may register an authenticated user ID through the IAP SDK 1410. The IAP SDK 1410 may request the online application store 1420 for a payment for an item with respect to the registered application based on the user ID. In response thereto, the IAP server 1430 may provide the terminal in which the application is installed with a single interface generated using a payment API for an integrated payment service through the IAP SDK 1410.

The terminal in which the application is installed may refer to payment details about the item in response to a success in payment through the IAP SDK 1410. The payment details may include at least one of an application ID, an ID of a market, an ID of a user, an ID of an item, a key value of an application, a payment state of the item, a price of the item, a payment date of the item, and a refund date of the item.

When the payment is completed, the IAP SDK 1410 may notify the user application server 1440 about the payment completion. The user application server 1440 may request the purchased item by notifying the IAP server 1430 about the payment completion to provide the item to the terminal in which the application is installed. In this example, the IAP server 1430 may inspect the payment validity between the user application server 1440 and the IAP server 1430 using a payment purchase token. When the payment is determined to be accurately performed, the IAP server 1430 may transfer the purchased item to the user application server 1440.

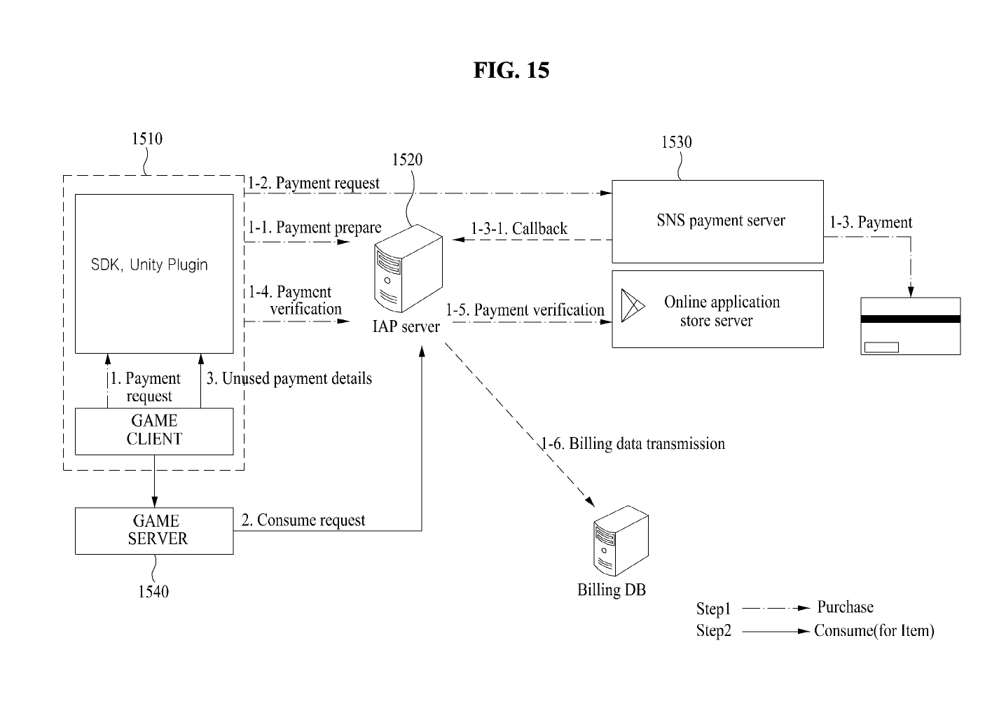

FIG. 15 illustrates a process of performing an integrated payment service at a cloud service system according to an exemplary embodiment.

The cloud service system may interact with an online application store based on information input from a service provider, and may register an item for the application based on information for interaction with a registered online application store. In response to a request for payment for the registered item from the application, the cloud service system may provide a terminal in which the application is installed with a single interface generated using a payment API for an integrated payment service.

Referring to FIG. 15, for example, a game application may be installed in a terminal 1510 and a user may use the game application through the terminal 1510 and may purchase an item in the game application. When the user requests a payment for the item, an IAP server 1520 may provide a single interface for an integrated payment service to the terminal 1510. The single interface for the integrated payment service may be provided to, for example, the terminal 1510 through an SDK.

The terminal 1510 may prepare a payment request by receiving the single interface. The user may request an online application store server or an SNS payment server 1530 for payment of at least one of the items for the application. For example, an online application store may be a market application such as Google Play and App Store. The SNS payment server 1530 may be an application capable of performing electronic transactions using a social network service, such as, for example, Facebook and Kakaotalk.

In response to the payment request from the user, the online application store server or the SNS payment server 1530 may perform the payment. The payment may be completed by transferring information about the payment request from the user to a card company. When the payment is performed, the online application store server or the SNS payment server 1530 may transfer callback about an API request result to the IAP server 1520.

The terminal 1510 may request the IAP server 1520 for payment verification to verify whether the payment is accurately performed. The IAP server 1520 may verify the payment based on information for interaction with the online application store registered by the service provider. The IAP server 1520 may inspect the payment validity using a payment purchase token in order to maintain a security. For example, the IAP server 1520 may verify a value using a mutually promised method through a signature key issued for each application.

The IAP server 1520 may perform the payment verification using the online application store server or the SNS payment server 1530 and may transmit billing data to a billing database. The billing database may store the billing data.

When the payment is completed, an application server 1540, for example, a game server may request a purchased item by notifying the IAP server 1520 about the payment completion to provide the item to the terminal 1510. When the payment is accurately performed, the IAP server 1520 may provide the item to the application server 1540. When the payment is inaccurately performed, the terminal 1510 may refer to unused payment details for verifying whether the payment for the item is completed.

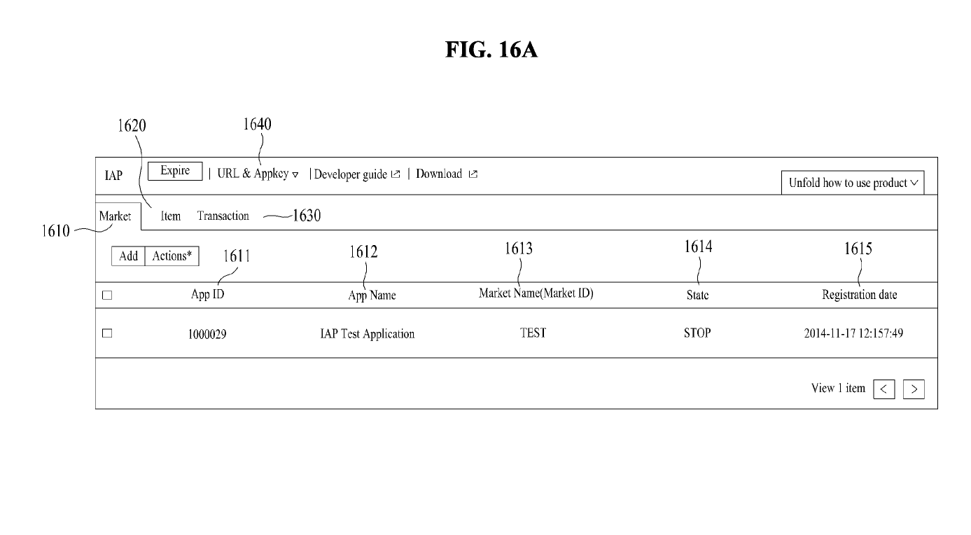

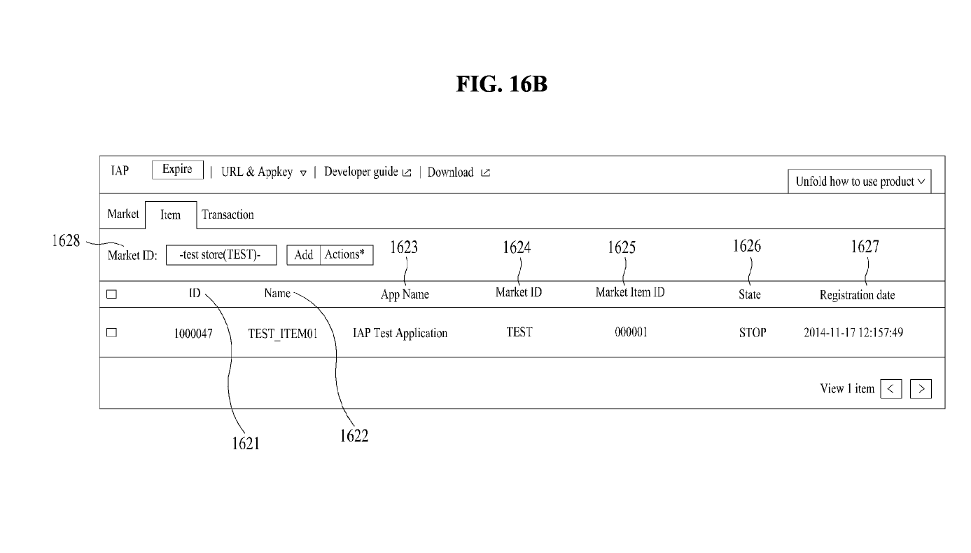

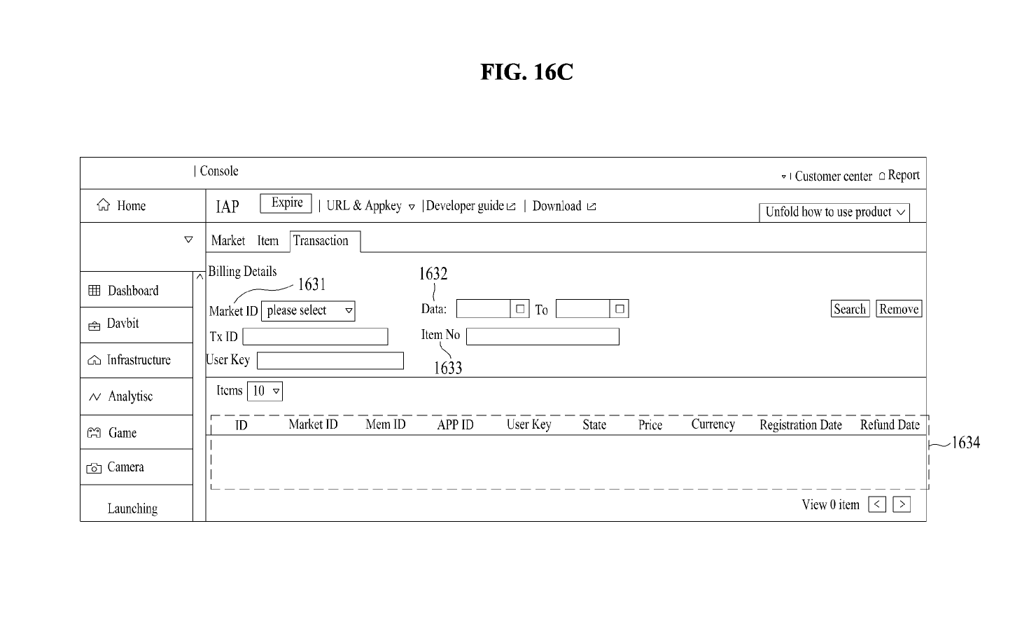

FIGS. 16A through 16C illustrate examples of an interface for providing an integrated payment service at a cloud service system according to an exemplary embodiment.

The cloud service system may provide an interface for providing an integrated IAP service through a website.

A service provider may select an IAP product use icon through the website. Referring to FIG. 16A, a website for providing an integrated IAP may provide, for example, a market tab 1610, an item tab 1620, and a transaction tab 1630, and may verify an application key value by selecting URL & Appkey 1640.

To register an online application store, the cloud service system may receive an application key value corresponding to at least one online application store among application key values issued from a plurality of online application stores. The cloud service system may register the issued application key value and information for interaction with an online application store, input from the service provider, through the website. The service provider may input information for interaction with the online application store by clicking on a website addition button. For example, the service provider may input at least one of an application ID 1611, an application name 1612, a market name 1613 of an application registered to the online application store, a state 1614 of the online application store, and a registration date 1615 on which the online application store is registered. Information for interaction with the online application store may be used to output a list of online application stores generated based on information input from the service provider. For example, an online application store list may be output such as application ID “1000029, application name “IAP Test Application”, package name “TEST” of the application registered to the online application store, state “STOP” of the online application store, and registration date “2014-11-17 12:57:49”.

Referring to FIG. 16B, the service provider may register an item for an application based on information for interaction with a registered online application store. For example, the service provider may select at least one market ID from among a plurality of market IDs 1628, and may register an item for an application to the selected market ID. For example, the service provider may register the item for the application by inputting an application ID 1621, an item name 1622, an application name 1623, a market ID 1624, a market item ID 1625, a state 1626, and an item registration date 1627. Here, information about an item registered in association with a market ID may be output. For example, information may be output such as application ID “1000047”, item name “TEST_ITEM01”, application name “IAP Test_Application”, market ID “000001”, state “USE”, and generation date “2014-11-17 12:57:49”.

Referring to FIG. 16C, a user may refer to payment information about an item through a website that provides a payment information reference interface. The user may select a market ID 1631 from information for interaction with an online application store, and may output payment information by inputting a start date and end date 1632 for verifying payment information about the market ID 1631. Also, the user may output payment information about the item by inputting an item number 1633. For example, when the user conducts a search by inputting the market ID 1631, the start date and end date 1632, and the item number 1633, payment information 1634 may be output based on input information. The payment information 1634 may include, for example, at least one of an application ID, a market ID, a user ID, an item ID, an application key value, a payment state of an item, a price of the item, a payment date of the item, and a refund date of the item. The payment state of the item may include, for example, at least one of a payment in progress, a payment success, and a payment failure.

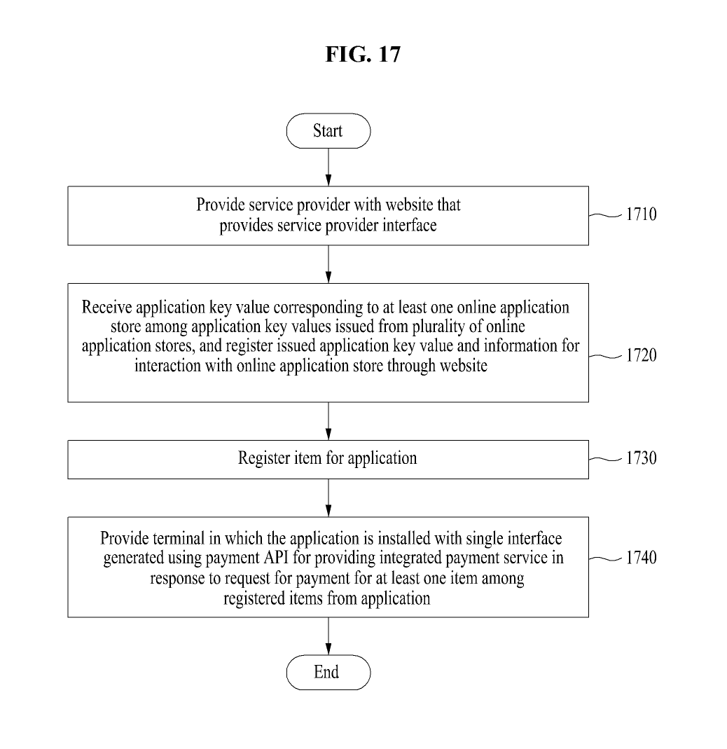

FIG. 17 is a flowchart illustrating a cloud service method of a cloud service system to provide an integrated payment service according to an exemplary embodiment.

In operation 1710, the cloud service system may provide a service provider with a website that provides a service provider interface.

In operation 1720, the cloud service system may receive an application key value corresponding to at least one online application store among application key values issued from a plurality of online application stores. The cloud service system may register the issued application key value and information for interaction with an online application store, input from the service provider, through the website. The cloud service system may output an online application store list including information for interaction with the online application store input from the service provider. Information for interaction with the online application store may include, for example, at least one of an ID of an application for interaction with the online application store, an application name, a package name of an application registered to the online application store, a state of the online application store, and a registration date on which the online application store is registered.

In operation 1730, the cloud service system may register an item for the application based on information for interaction with the registered online application store.

In operation 1740, the cloud service system may provide the terminal in which the application is installed with a single interface generated using a payment API for providing an integrated payment service in response to a request for payment for at least one item among registered items from the application. Here, the single interface may include a function of controlling the terminal to process at least one integrated payment service among a payment request for an item from an online application store, a payment verification request for determining whether the payment for the item is accurately performed from the online application store, and a payment details reference request for referring to payment details of the item.

The cloud service system may determine whether the requested payment for the item is performed, may inspect the payment validity using a payment purchase token for maintaining a security, and may transfer the purchased item to the application in response to completing the requested payment for the item.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to be or being interpreted by the processing device. The software also may be distributed over network coupled computer systems so that the software is stored and executed in a distributed fashion. For example, the software and data may be stored by one or more computer readable recording mediums.

The above-described exemplary embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few example embodiments have been shown and described, the present disclosure is not limited to the described example embodiments. Instead, it would be appreciated by those skilled in the art that changes may be made to these example embodiments without departing from the principles and spirit of the disclosure, the scope of which is defined by the claims and their equivalents.

What is claimed is:

1. A cloud service method of a cloud service system, the method comprising:
providing a service provider comprising a website that provides a service provider interface;
receiving an application key value corresponding to at least one online application store among application key values issued from online application stores;
registering the issued application key value and information for interaction with an online application store, input from the service provider, through the website;
registering an item for an application based on the information; and
providing a terminal in which the application is installed with a single interface generated using a payment application programming interface (API) for providing an integrated payment service in response to a request for payment for at least one item among registered items from the application.

2. The method of claim 1, wherein the single interface controls the terminal to process at least one integrated payment service among a payment request for an item from the online application store, a payment verification request for determining whether the payment for the item is accurately performed from the online application store, and a payment details reference request for referring to payment details of the item.

3. The method of claim 1, further comprising:
providing a payment information reference interface configured to output payment details associated with the registered item through the website.

4. The method of claim 3, wherein the providing of the payment information reference interface comprises:
outputting payment information details by receiving a user selection on an identifier (ID) of a market in the information, and
inputting a start date and an end date for verifying payment information about the ID of the market.

5. The method of claim 4, wherein the payment information about the item comprises at least one of an ID of the application, the ID of the market, an ID of a user, an ID of the item, a key value of the application, a payment state of the item, a price of the item, a payment date of the item, and a refund date of the item, and
the payment state of the item comprises at least one of a payment in progress, a payment success, and a payment failure.

6. The method of claim 1, wherein the registering comprises:
outputting an online application store list comprising the information input from the service provider, wherein the information comprises at least one of an ID of an application for interaction with the online application store, an application name, a package name of an application registered to the online application store, a state of an online application store, and a registration date on which the online application store is registered.

7. The method of claim 1, wherein the providing the terminal in which the application is installed comprises:
determining whether the requested payment for the item is performed, and inspecting a payment validity using a payment purchase token for maintaining security; and
transferring the purchased item to the application in response to completing the requested payment for the item.

8. The method of claim 7, wherein the providing the terminal in which the application is installed comprises:
providing an interface for referring to unused payment details to verify whether the payment for the item is completed, in response to a failure in the requested payment for the item.

9. A cloud service system comprising:
an interfacer configured to provide a service provider with a website that provides a service provider interface;
an online market registerer configured to receive an application key value corresponding to at least one online application store among application key values issued from online application stores, and to enable the service provider to register the issued application key value and information for interaction with an online application store, through the website;
an item registerer configured to register an item for an application based on the information; and
a payment provider configured to provide a terminal in which the application is installed with a single interface generated using a payment application programming interface (API) for providing an integrated payment service in response to a request for payment for at least one item among registered items from the application.

10. The cloud service system of claim 9, wherein the single interface controls the terminal to process at least one integrated payment service among a payment request for an item from the online application store, a payment verification request for determining whether the payment for the item is accurately performed from the online application store, and a payment details reference request for referring to payment details of the item.

11. The cloud service system of claim 9, further comprising:
a payment information referrer configured to provide a payment information reference interface for outputting payment details for the registered item through the website.

12. The cloud service system of claim 11, wherein the payment information referrer is configured to output payment information details by receiving a user selection on an identifier (ID) of a market in the information, and by inputting a start date and an end date for verifying payment information about the ID of the market.

13. The cloud service system of claim 12, wherein the payment information about the item comprises at least one of an ID of the application, the ID of the market, an ID of a user, an ID of the item, a key value of the application, a payment state of the item, a price of the item, a payment date of the item, and a refund date of the item, and
the payment state of the item comprises at least one of a payment in progress, a payment success, and a payment failure.

14. The cloud service system of claim 9, wherein the market registerer is configured to output an online application store list comprising the information registered by the service provider, wherein the information comprises at least one of an ID of an application for interaction with the online application store, an application name, a package name of an application registered to the online application store, a state of an online application store, and a registration date on which the online application store is registered.

15. The cloud service system of claim 9, wherein the payment provider is configured to determine whether the requested payment for the item is performed, to inspect a payment validity using a payment purchase token for maintaining security, and to transfer the purchased item to the application in response to completing the requested payment for the item.

16. The cloud service system of claim 15, wherein the payment provider is configured to provide an interface for referring to unused payment details to verify whether the payment for the item is completed, in response to a failure in the requested payment for the item.
